(19) United States
(12) Patent Application Publication
(10) Pub. No.: US 2023/0229056 A1
(43) Pub. Date: Jul. 20, 2023

(54) LIGHT SOURCE UNIT, OPTICAL ENGINE INCLUDING THE SAME, SMART GLASS, OPTICAL COMMUNICATION TRANSMISSION DEVICE, AND OPTICAL COMMUNICATION SYSTEM

(71) Applicant: TDK CORPORATION, Tokyo (JP)

(72) Inventors: Hideaki FUKUZAWA, Tokyo (JP); Joji OKADA, Tokyo (JP); Takashi KIKUKAWA, Tokyo (JP); Tsuyoshi KOMAKI, Tokyo (JP)

(73) Assignee: TDK CORPORATION, Tokyo (JP)

(21) Appl. No.: 18/097,881

(22) Filed: Jan. 17, 2023

(30) Foreign Application Priority Data
Jan. 17, 2022 (JP) 2022-005124

(51) Int. Cl. G02F 1/21; G02F 1/035; G02F 1/01; H04B 10/50; G02B 27/01

(52) U.S. Cl. CPC G02F 1/212; G02B 27/0172; G02F 1/035; G02F 1/0123; H04B 10/505; G02B 2027/0178

(57) ABSTRACT

A light source unit (1000) of the present disclosure includes a light source part (100), a first electrical signal generating device (40-1) configured to control current that drives an optical semiconductor device (30), an optical modulator (200) having a Mach-Zehnder type optical waveguide (10) and an electrode configured to apply an electric field to the optical waveguide (10), and a second electrical signal generating device (40-2) configured to control a voltage that operates the optical modulator (200), the first electrical signal generating device (40-1) and the second electrical signal generating device (40-2) are synchronizably connected to each other, and intensity of light emitted from the optical modulator (200) is changed by the current controlled by the first electrical signal generating device (40-1) and the voltage controlled by the second electrical signal generating device (40-2).

### CROSS-REFERENCE TO RELATED APPLICATION

Priority is claimed on Japanese Patent Application No. 2022-005124, filed Jan. 17, 2022, the content of which is incorporated herein by reference.

### BACKGROUND OF THE INVENTION

### Field of the Invention

The present disclosure relates to a light source unit, an optical engine including the same, a smart glass, an optical communication transmission device, and an optical communication system.

### Description of Related Art

An augmented reality (AR) glass and a virtual reality (VR) glass are anticipated as small wearable devices. In such a device, a light-emitting device that emits full-color visible lights is one of the crucial devices for drawing high-quality images. In such a device, for example, the light emitting device expresses a moving image in desired colors by modulating intensity of each of three colors of RGB that express visible light at a high speed independently.

As such a light emitting device, Patent Literature 1 discloses a light emitting device configured to project a color moving image by causing a laser of visible light to enter a waveguide and controlling emission intensity of a laser chip of each color using current. In addition, Patent Literature 2 discloses a modulator configured to independently modulate intensity of each of three colors of RGB using an external modulator by causing a laser beam to enter the external modulator having a waveguide formed in a substrate having an electro-optic effect via an optical fiber.

In a wearable device such as an AR glass or a VR glass, a key to popularization of the light emitting module is miniaturization such that each function fits within a size of a conventional spectacle type.

In the light emitting device disclosed in Patent Literature 1, while emission intensity of a laser is directly controlled by current in current control, it is necessary to control the current in a linear region of a current-optical output graph in order to secure stability of the emission intensity, in current control. For this reason, there is a problem that power consumption is great and is difficult to reduce.

In addition, Patent Literature 2 discloses an optical modulator in which an optical waveguide is provided on a substrate formed of materials such as lithium niobate (LN : LiNbO₃), lithium tantalite (LT: LiTaO₃ lead lanthanum zirconate titanate (PLZT), potassium phosphate titanate (KTiOPO₄), polythiophene, a liquid crystal material, and various induced polymers, which have electro-optic effects. An aspect in which a part of a single crystal or a solid solution crystal, particularly of lithium niobate among these, is modified by a proton exchange method or a Ti diffusion method to form an optical waveguide, is disclosed as a preferred aspect. However, since a size of the modified waveguide portion (core) region is defined by a distance where a proton or Ti is introduced and diffused, it is difficult to reduce a diameter of the optical waveguide. For this reason, since the size of the optical waveguide itself must be large, it is difficult to concentrate an electric field of a modulation voltage due to a large diameter of the optical waveguide, it is necessary to apply a large voltage for modulation, or it is necessary to lengthen the electrode to which the voltage is applied to operate the electrode with a small voltage, the size of the device becomes large.

In addition, in a modulator shown in the lower view of FIG. 36 in which a portion B1-a in which a part of a single crystal B1 of bulk lithium niobate is modified is used as an optical waveguide, since a small amount of Ti is added to the bulk lithium niobate single crystal to create a refractive index difference Δn, a refractive index difference between a modified waveguide portion (core) and a non-modified portion (cladding) is small. For this reason, since a bending loss caused by curving the optical waveguide is large and the optical waveguide cannot be curved with a high curvature, it is difficult to reduce the size of the device. In addition, in a modulation light source mounted on a head mount display such as an AR glass or the like, for example, while a size that fits within a string size of spectacles is required, it is difficult to fabricate an optical modulator miniaturized to such a size in the bulk crystal type optical modulator disclosed in Patent Literature 2.

A modulator, in which a convex section Fridge obtained by processing a single crystal lithium niobate film F epitaxially grown on a substrate such as sapphire or the like as shown in the upper view of FIG. 36 is used as an optical waveguide, is known in comparison with the modulator in which the portion B1-a obtained by modifying a part of the single crystal B1 of lithium niobate is used as the optical waveguide. The modulator is suitable for miniaturization for reasons such as the size of the convex portion being smaller than that of the Ti diffusion optical waveguide, the fact that the refractive index difference Δn can be increased when surrounding materials are selected appropriately because the entire area around the convex part corresponds to the cladding, and the optical loss when the optical waveguide is curved being smaller than that of the bulk lithium niobate single crystal.

In addition, FIG. 7 of Patent Literature 2 discloses an optical module 100 in which a light source part 311 and a modulator 30 are provided as a module that is a configuration unit, the light source part 311 is not directly modulated, and light externally modulated by the modulator 30 can be emitted. Like the optical module 100 disclosed in Patent Literature 2, when the optical module having the configuration multiplexed after laser beams of red (R), green (G) and blue (G) are output from the modulator 30 is used as a component of an optical engine, since the optical system becomes large as will be described below, it is difficult to reduce the size of the optical engine.

In addition, in order to display an image with desired colors, while it is necessary to independently modulate the intensity of each of three colors of RGB that express visible light at a high speed, when such modulation is performed only by a light source or an optical modulator, the load on the IC that controls those modulations may be increased.

### Patent Literature

[Patent Literature 1] Japanese Unexamined Patent Application, First Publication No. 2021-86976
[Patent Literature 2]Japanese Patent No. 6728596
[Patent Literature 3]Japanese Unexamined Patent Application, First Publication No. 2001-292107

### SUMMARY OF THE INVENTION

In consideration of the above-mentioned problems, the present disclosure is directed to providing a light source unit, an optical engine including the same, a smart glass, an optical communication transmission device, and an optical communication system, which have a small size and low power consumption, and can be mounted on an AR glass, a VR glass, or the like.

The present disclosure provides the following means.

A light source unit according to a first aspect of the present disclosure includes a light source part having an optical semiconductor device; a first electrical signal generating device configured to generate an electrical signal to control current that drives the optical semiconductor device; an optical modulator having a Mach-Zehnder type optical waveguide with a lithium niobate film processed in a convex shape, and an electrode configured to apply an electric field to the Mach-Zehnder type waveguide; and a second electrical signal generating device configured to generate an electrical signal to control a voltage that operates the optical modulator, the optical semiconductor device and the optical modulator are optically connected to each other, the first electrical signal generating device and the second electrical signal generating device are synchronizably connected to each other; and the intensity of light emitted from the optical modulator is changed by current modulation controlled by the first electrical signal generating device and voltage modulation controlled by the second electrical signal generating device.

In the light source unit according to the above aspect, the first electrical signal generating device and the second electrical signal generating device may be formed on a common semiconductor substrate.

In the light source unit according to the above aspect, a minimum value of a change of light intensity by the first electrical signal generating device may be greater than a minimum value of a change of light intensity by the second electrical signal generating device.

In the light source unit according to the above aspect, a minimum value of a change of light intensity by the second electrical signal generating device may be greater than a minimum value of a change of light intensity by the first electrical signal generating device.

In the light source unit according to the above aspect, a peak wavelength of the optical semiconductor device may be visible light of 380 nm to 830 nm.

In the light source unit according to the above aspect, a peak wavelength of the optical semiconductor device may be near infrared light of 830 nm to 2000 nm.

The light source unit according to the above aspect may further include a plurality of optical modules in which the optical semiconductor devices and the optical modulators are optically connected, and the plurality of optical modules may be independently controlled.

In the light source unit according to the above aspect, light emitted from the optical modulators of the different optical modules of the plurality of optical modules may be emitted from separate light exit ports.

The light source unit according to the above aspect may further include a multiplexing part configured to multiplex the light from the different optical modules of the plurality of optical modules, and the multiplexed light passing through the multiplexing part may be emitted from one light exit port.

In the light source unit according to the above aspect, the optical semiconductor devices of the different optical modules may emit visible light with a peak wavelength of 380 nm to 830 nm, and light emitted from the light exit port may be visible light.

In the light source unit according to the above aspect, the plurality of optical modules may have at least: a blue optical module having the optical semiconductor device with a peak wavelength of 380 nm to 500 nm; a green optical module having the optical semiconductor device with a peak wavelength or 500 nm to 600 nm; and a red optical module having the optical semiconductor device with a peak wavelength of 600 nm to 830 nm, and a visible light multiplexing part configured to multiplex the light from the red optical module, the light from the green optical module and the light from the blue optical module may be provided, and the multiplexed visible light passing through the visible light multiplexing part may be emitted from one visible light exit port.

The light source unit according to the having aspect may further include a near infrared light module having an optical semiconductor device that emits near infrared light with a peak wavelength of 830 nm or more, and a near infrared light exit port from which the near infrared light is emitted may be provided separately from the visible light exit port.

The light source unit according to the having aspect may further include a near infrared light module having an optical semiconductor device that emits near infrared light with a peak wavelength of 830 nm or more, a multiplexing part configured to multiplex the visible light emitted from the visible light multiplexing part and the near infrared light emitted from the near infrared light module may be provided, and the multiplexed light passing through the multiplexing part may be emitted from one light exit port.

An optical engine according to a second aspect of the present disclosure includes the light source unit according to the above-mentioned aspect; an optical scanning mirror configured to scan light emitted from the light source unit in different directions; and a control device configured to control the optical scanning mirror.

A smart glass according to a third aspect of the present disclosure includes the optical engine according to the above-mentioned aspect, and a spectacle frame.

An optical communication transmission device according to a fourth aspect of the present disclosure includes the light source unit according to the above-mentioned aspect.

An optical communication system according to a fifth aspect of the present disclosure includes the optical communication transmission device according to the above-mentioned aspect, and an optical communication receiving device having an optical signal receiving device configured to receive light.

According to the present disclosure, it is possible to provide a light source unit that has a small size and low power consumption and can be mounted on an AR glass, a VR glass, or the like.

### BRIEF DESCRIPTION OF THE DRAWINGS

FIG. 1 is a conceptual view of a light source unit according to an embodiment.

FIG. 2 is a plan view schematically showing the light source unit according to the embodiment.

FIG. 3 is a schematic cross-sectional view cut along line X-X in FIG. 2.

FIG. 4 is a schematic cross-sectional view cut along line Y-Y in FIG. 2.

FIG. 5 is a block diagram of an optical modulator 200.

FIG. 6 is a view showing an optical modulation curve in each Mach-Zehnder type optical waveguide.

FIG. 7A is a conceptual view of one example of the adjustment methods of changing light intensity together with current modulation to an optical semiconductor device and voltage modulation to an optical modulator.

FIG. 7B is a conceptual view of the other example of the adjustment methods of changing light intensity together with current modulation to an optical semiconductor device and voltage modulation to an optical modulator.

FIG. 8A shows that a laser beam (LB) is scanned over time to cover the entire image area.

FIG. 8B is a graph in which the horizontal axis represents time, and the vertical axis represents the color tone of RGB three colors.

FIG. 9 is a conceptual view of a control method when an image is formed in the image forming device including the light source unit according to the embodiment.

FIG. 10 is a plan view schematically showing the light source unit having a multiplexing part.

FIG. 11A is a view schematically showing an MMI type multiplexer.

FIG. 11B is a view schematically showing an MMI type multiplexer.

FIG. 11C is a view schematically showing a Y type multiplexer.

FIG. 11D is a view schematically showing a directional multiplexer.

FIGS. 12A, 12B, and 12C show a first configuration example for bringing the ratio of light output of each color closer to 1:1:1.

FIGS. 13A, 13B, and 13C show a second configuration example for bringing the ratio of light output of each color closer to 1:1:1.

FIGS. 14A, 14B, and 14C show a third configuration example for bringing the ratio of light output of each color closer to 1:1:1.

FIG. 15 is a plan view schematically showing a Mach-Zehnder type optical waveguide having a curved part.

FIG. 16 is a plan view schematically showing a light source unit according to another embodiment.

FIG. 17 is a schematic plan view for describing a stray light propagation prevention part.

FIG. 18 is a cross-sectional view cut along line A-A′ of FIG. 17.

FIG. 19 is a cross-sectional view cut along line B-B′ of FIG. 17.

FIG. 20 is a cross-sectional view showing another formation example of a groove section.

FIG. 21 is a cross-sectional view showing another formation example of a light absorption layer.

FIG. 22 is a plan view of an optical modulator according to another embodiment when viewed from above.

FIG. 23 is a plan view of an optical modulator according to still another embodiment when viewed from above.

FIG. 24 is a plan view of an optical modulator according to yet another embodiment when viewed from above.

FIG. 25 is a cross-sectional view cut along line C-C′ in FIG. 24.

FIG. 26 is a plan view of an optical modulator according to yet another embodiment when viewed from above.

FIG. 27 is a conceptual view for describing an optical engine according to the embodiment.

FIG. 28 is a conceptual view showing an aspect in which an image is directly projected to the retina by a laser beam emitted from the light source unit according to the embodiment.

FIG. 29A is a view schematically showing an optical engine having no multiplexer in a modulation device, and FIG. 29B is a view schematically showing an optical engine according to the embodiment having a multiplexing part in the light source unit.

FIG. 30 is a conceptual view for describing an optical communication transmission device according to the embodiment and a visible light signal generated in a transmission device thereof.

FIG. 31 is a block diagram of an optical communication system according to the embodiment.

FIG. 32 is a block diagram showing a variant of a communication system according to the embodiment.

FIG. 33 is a view showing an example of a use example of an information terminal according to the embodiment.

FIG. 34 is a view showing another example of the use example of the information terminal according to the embodiment.

FIG. 35 is a view showing yet another example of the use example of the information terminal according to the embodiment.

FIG. 36 shows a conceptual view for describing a modulator in which a portion obtained by modifying a part of a single crystal of bulk lithium niobate is used as an optical waveguide, and a conceptual view for describing a modulator in which a convex section obtained by processing a single crystal lithium niobate film is used as an optical waveguide.

### DETAILED DESCRIPTION OF THE INVENTION

Hereinafter, the present disclosure will be described in detail with reference to the accompanying drawings. In the drawings used in the following description, in order to make it easier to understand the features of the present disclosure, the characteristic portions may be enlarged for convenience, and dimensional ratios or the like of the components may differ from the actual ones. The materials, dimensions, or the like, exemplified in the following description are examples, and the present disclosure is not limited thereto and may be implemented with appropriate changes without departing from the spirit of the present disclosure.

### Light Source Unit

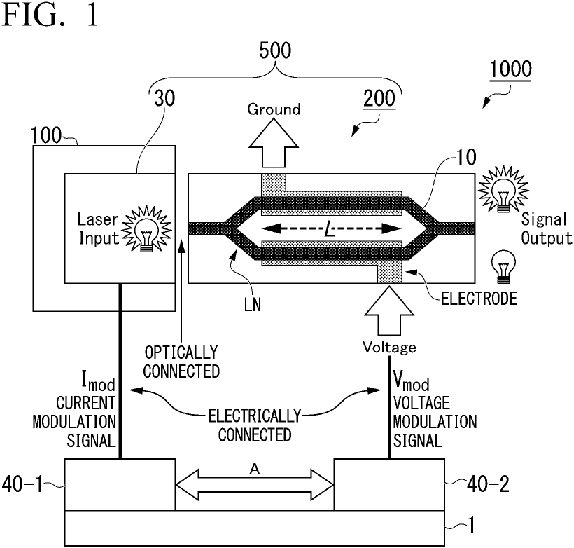

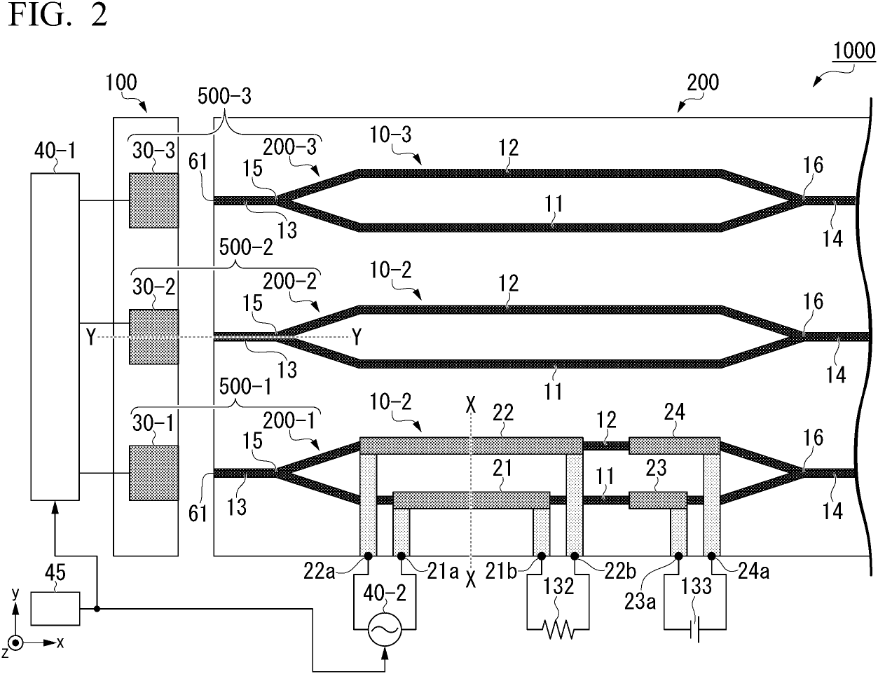

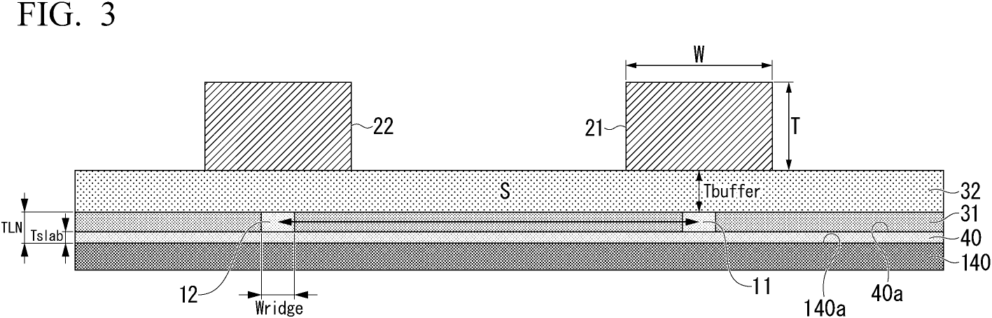

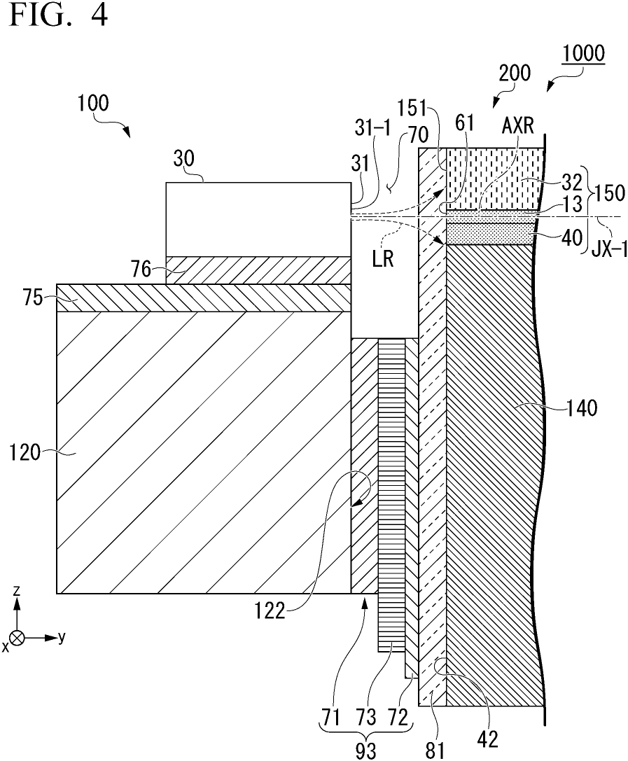

FIG. 1 is a conceptual view of a light source unit of an embodiment. FIG. 2 is a plan view schematically showing the light source unit according to the embodiment. In FIG. 2, an electrode configured to apply a phase difference to a Mach-Zehnder type optical waveguide is only partially drawn. FIG. 3 is a schematic cross-sectional view cut along line X-X in FIG. 2. FIG. 4 is a schematic cross-sectional view cut along line Y-Y in FIG. 2.

A light source unit 1000 shown in FIG. 1 includes a light source part 100 having an optical semiconductor device 30, a first electrical signal generating device 40-1 configured to generate an electrical signal to control current that drives the optical semiconductor device 30, an optical modulator 200 having an electrode configured to apply an electric field to the Mach-Zehnder type optical waveguide 10 and a Mach-Zehnder type optical waveguide 10 formed by processing a lithium niobate film in a convex shape, and a second electrical signal generating device 40-2 configured to generate an electrical signal to control a voltage that operates the optical modulator 200, the optical semiconductor device 30 is disposed such that the light emitted from optical semiconductor device 30 the can enter a light incident port of the waveguide 10, i.e., the optical semiconductor device 30 and the optical modulator 200 are optically connected to each other, the first electrical signal generating device 40-1 and the second electrical signal generating device 40-2 are synchronizably connected to each other (reference sign A in FIG. 1), and the intensity of the light emitted from the optical modulator 200 is changed by the current controlled by the first electrical signal generating device 40-1 and the voltage controlled by the second electrical signal generating device 40-2.

The first electrical signal generating device 40-1 and the second electrical signal generating device 40-2 can control modulation of the intensity of the light emitted from the optical modulator 200 to match the timing of each modulation signal.

In the light source unit 1000, the intensity of the light emitted from the optical modulator 200 can be modulated by overlapping the current modulation that drives the optical semiconductor device 30 using the first electrical signal generating device 40-1 and the voltage modulation that operates the optical modulator 200 using the second electrical signal generating device 40-2. For this reason, Therefore, the load on each analog IC (electric signal generating device) is suppressed compared with a configuration in which the light intensity emitted from the modulator is changed only by current modulation to drive the optical semiconductor device or by voltage modulation to operate the optical modulator. For example, when changing colors at a high frequency of 1 GHz to obtain a pixel resolution of 2560 × 1460, it must be modulated at a high frequency of GHz if it is carried by a single analog IC (electrical signal generating device). On the other hand, when two analog ICs (electric signal generating devices) are used, it is sufficient to modulate them at frequencies of several 100 MHz each.

In such a configuration, while two types of analog ICs (electrical signal generating devices) are required, the entire system can be simplified by providing them on a common substrate 1 and making them into one chip as shown in FIG. 1. The substrate 1 may be any substrate capable of forming an analog IC, for example, a semiconductor substrate such as silicon or the like.

In order to stabilize oscillation of the optical semiconductor device (laser), the first electrical signal generating device 40-1 may apply low frequency modulation, and the second electrical signal generating device 40-2 may apply high frequency modulation.

The light source unit 1000 shown in FIG. 2 includes three optical modules 500 in which the optical semiconductor devices 30 and the optical modulators 200 are optically connected to each other. That is, the light source unit 1000 has an optical module 500-1 in which an optical semiconductor device 30-1 and an optical modulator 200-1 are optically connected, an optical module 500-2 in which an optical semiconductor device 30-2 and an optical modulator 200-2 are optically connected, and an optical module 500-3 in which an optical semiconductor device 30-3 and an optical modulator 200-3 are optically connected.

The light source unit 1000 shown in FIG. 2 is a configuration with three optical modules 500, but the number of the optical module is not limited and may be one, two, or four or more.

The optical module 500-1, the optical module 500-2, and the optical module 500-3 can be controlled independently. That is, each of the optical semiconductor device 30-1, the optical semiconductor device 30-2, and the optical semiconductor device 30-3 can control current modulation independently driven by the first electrical signal generating device 40-1. In addition, each of the optical modulator 200-1, the optical modulator 200-2, and the optical modulator 200-3 can control voltage modulation independently operated by the second electrical signal generating device 40-2. Further, in the optical module of each of the optical module 500-1, the optical module 500-2, and the optical module 500-3, the modulation is performed at an independent timing by each of the first electrical signal generating device 40-1 and the second electrical signal generating device 40-2, which are synchronizably connected to each other, and the intensity of the light emitted from each of the optical modulators can be changed.

Further, in FIG. 2, in order to make the features easier to see, the electrode configured to apply an electric field to the Mach-Zehnder type optical waveguide is drawn only for the optical modulator 200-1, and not for the optical modulator 200-2 or the optical modulator 200-3.

In the light source unit 1000, the optical semiconductor devices 30-1, 30-2 and 30-3 are mounted on a sub-carrier (base) 120, and the Mach-Zehnder type optical waveguides 10-1, 10-2 and 10-3 are formed on the substrate 140 (see FIG. 4).

In the light source unit 1000, by using the optical waveguide obtained by processing the single crystal lithium niobate thin film in a convex shape, the size of the optical waveguide can be reduced to 1 mm or less, and the light source unit can be reduced in size. In addition, since an extremely highly insulated external modulator is controlled by a voltage, it requires very little current for intensity modulation, and has low power consumption because it operates with the minimum current required for laser emission.

In terms of miniaturization, further, in comparison with the case in which the bulk lithium niobate single crystal is used when the optical waveguide is fabricated, advantages of using the lithium niobate film when the optical waveguide is fabricated will be described.

When the bulk lithium niobate single crystal is used to fabricate the optical waveguide, the Ti diffusion waveguide diffuses Ti in the bulk lithium niobate single crystal, and a portion with a higher refractive index than the original single crystal therearound is fabricated. On the other hand, in the case in which the lithium niobate film is used to fabricate the optical waveguide, the lithium niobate film is processed to fabricate a convex portion that becomes the optical waveguide. The convex portion is smaller than the Ti diffusion waveguide.

Further, when the bulk lithium niobate single crystal is used, the refractive index difference Δn between the Ti diffusion waveguide (core) and the single crystal portion (cladding) therearound is small. This is because a small amout of Ti is added into the bulk lithium niobate single crystal to fabricate the refractive index difference Δn. On the other hand, when the lithium niobate film is used, since the entire area around the convex part (core) corresponds to the cladding, the refractive index difference, Δn, can be increased when the surrounding materials (the side and top materials of the sapphire substrate and the waveguide) are properly selected. As a result, the optical waveguide can be curved with high curvature, and the size in the longitudinal direction can be reduced by the curve. Further, since an interaction length can be increased while keeping the size in the longitudinal direction small, a driving voltage can be lowered.

### (Optical Semiconductor Device)

As the optical semiconductor device 30, various types of laser devices can be used. For example, laser diodes (LDs) of red light, green light, blue light, near infrared light, and the like, which are commercially available, can be used. Light with a peak wavelength of 600 nm or more and 830 nm or less can be used for the red light, light with a peak wavelength of 500 nm or more and 600 nm or less can be used for the green light, and light with a peak wavelength of 380 nm or more and 500 nm or less can be used for the blue light. In addition, light with a peak wavelength of 830 nm or more and 2000 nm or less can be used for the near infrared light.

In the light source unit 1000 shown in FIG. 2, the optical semiconductor devices 30-1, 30-2 and 30-3 are referred to as an LD configured to emit blue light, an LD configured to emit green light, and an LD configured to emit red light, respectively. The LDs 30-1, 30-2 and 30-3 are disposed at intervals in a direction substantially perpendicular to an emission direction of the light emitted from each of the LDs, and provided on an upper surface 121 of the sub-carrier 120. Hereinafter, regarding reference sign Z of an arbitrary component, contents common to components of reference signs Z-1, Z-2, ..., Z-K may be collectively described as reference sign Z. The above-mentioned K is a natural number of 2 or more.

In the light source unit 1000 shown in FIG. 2, while the case in which the number of the optical semiconductor devices is three has been shown, it is not limited to three and may be plural such as two, or four or more. The plurality of optical semiconductor devices may all emit light with different wavelengths, or may be optical semiconductor devices that emit light with the same wavelength. In addition, light other than red (R), green (G) and blue (B) can also be used for the emitting light, and an order of installation of red (R), green (G), blue (B) described using the drawings also need not to be this order and may be changed as appropriate.

The optical semiconductor devices 30-1, 30-2 and 30-3 are connected to the first electrical signal generating device 40-1 that independently generates electrical signals for controlling the driving current for the optical semiconductor devices 30-1, 30-2 and 30-3.

The first electrical signal generating device 40-1 is connected to a synchronization signal generating device 45 together with the second electrical signal generating device 40-2 that generates an electrical signal for controlling the voltage for operating the optical modulator 200, and the intensity of the light emitted from the optical modulation element 200 can be changed by synchronizing the timing of each modulation signal with the synchronization signal generated from the synchronization signal generator 45.

The LD 30 can be mounted on the sub-carrier 120 as a bare chip. The sub-carrier 120 is formed of, for example, aluminum nitride (A1N), aluminum oxide (A1₂O₃), silicon (Si), or the like. As shown in FIG. 4, metal layers 75 and 76 are provided between the sub-carrier 120 and the LD 30. The sub-carrier 120 and the LD 30 are connected via the metal layers 75 and 76. A method of forming the metal layers 75 and 76 is not particularly limited and any known method can be used, and a known method such as sputtering, deposition, application of a paste metal, or the like, can be used. The metal layers 75 and 76 may include one or a plurality of metals selected from the group consisting of, for example, gold (Au), platinum (Pt), silver (Ag), lead (Pb), indium (In), nickel (Ni), titanium (Ti), tantalum (Ta), a tungsten (W), gold (Au) and tin (Sn) alloy, a tin (Sn)-silver (Ag)-copper (Cu)-based solder alloy (SAC), SnCu, InBi, SnPdAg, SnBiIn and PbBiIn, or may be formed of one or a plurality of metals selected from the group.

While the substrate 140 is not particularly limited as long as a refractive index is lower than a lithium niobate film constituting the Mach-Zehnder type optical waveguide, a substrate that allows a single crystal lithium niobate films to be formed as an epitaxial film is preferable, and a sapphire single crystal substrate or a silicon single crystal substrate is preferable. While a crystal orientation of the single crystal substrate is not particularly limited, for example, since a c-axis oriented lithium niobate film has a 3-fold symmetry property, it is desirable that the underlying single crystal substrate also has the same symmetry property, a c-plane substrate is preferable for a sapphire single crystal substrate, and a (111) plate substrate is preferable for a silicon single crystal substrate.

As shown in FIG. 4, a light incident port 61 of an incident portion 13 of each of the Mach-Zehnder type optical waveguides 10 faces an emission port 31-1 of each of the LDs 30, light emitted from an emission surface 31 of the LD 30 is positioned to enter the incident portion 13, and the LDs 30 and the Mach-Zehnder type optical waveguides 10 are optically connected, respectively. An axis JX-1 of the incident portion 13 substantially overlaps an optical axis AXR of a laser beam LR emitted from the emission port 31-1 of the LD 30. The blue light, green light and red light emitted from the LDs 30-1, 30-2 and 30-3 according to such configuration and disposition can enter the incident portion 13 of each of the Mach-Zehnder type optical waveguides 10.

As shown in FIG. 4, the sub-carrier 120 can be directly joined to the substrate 140 via a metal layer 93 (a first metal layer 71, a second metal layer 72, and a third metal layer 73). According to the configuration, further miniaturization is possible by eliminating spatial coupling or fiber coupling.

In the embodiment, a side surface (a first side surface) 122 facing the substrate 140 in the sub-carrier 120 and a side surface (a second side surface) 42 facing the sub-carrier 120 in the substrate 140 are connected via the first metal layer 71, the second metal layer 72, the third metal layer 73, and an anti-reflection film 81. A melting point of the metal layer 75 is higher than a melting point of the third metal layer 73.

The first metal layer 71 is formed the side surface 122 by sputtering, deposition, or the like, may include one or a plurality of metals selected from the group consisting of, for example, gold (Au), platinum (Pt), silver (Ag), lead (Pb), indium (In), nickel (Ni), titanium (Ti) and tantalum (Ta), and may be formed of one or a plurality of metals selected from the group. Preferably, the first metal layer 71 includes at least one metal selected from the group consisting of gold (Au), platinum (Pt), silver (Ag), lead (Pb), indium (In), and nickel (Ni). The second metal layer 72 is formed on the side surface 42 by sputtering, deposition, or the like, may include one or a plurality of metals selected from the group consisting of, for example, titanium (Ti), tantalum (Ta) and tungsten (W), and may be formed of one or a plurality of metals selected from the group. Preferably, tantalum (Ta) is used in the second metal layer 72. The third metal layer 73 is interposed between the first metal layer 71 and the second metal layer 72, may include one or a plurality of metals selected from the group consisting of, for example, aluminum (Al), copper (Cu), AuSn, SnCu, InBi, SnAgCu, SnPdAg, SnBiIn and PbBiIn, and may be formed of one or a plurality of metals selected from the group. Preferably, AuSn, SnAgCu, and SnBiIn are used in the third metal layer 73.

A thickness of the first metal layer 71, i.e., a size of the first metal layer 71 in the y direction is, for example, 0.01 µm or more and 5.00 µm or less. A thickness of the second metal layer 72, i.e., a size of the second metal layer 72 in the y direction is, for example, 0.01 µm or more and 1.00 µm or less. A thickness of the third metal layer 73, i.e., a size in the y direction is, for example, 0.01 µm or more and 5.00 µm or less. In addition, a thickness of the third metal layer 73 is preferably greater than a thickness of each of the first metal layer 71 and the second metal layer 72. In such a configuration, the above-mentioned roles of the first metal layer 71, the second metal layer 72, and the third metal layer 73 are well exhibited, and intrusion of the material of the first metal layer 71 into the substrate 140 and a decrease in adhesion strength of the metal layers are suppressed. A thickness of the first metal layer 71, the second metal layer 72 and the third metal layer 73 is measured by, for example, spectral ellipsometry.

The first metal layer 71 is provided on a side surface facing the substrate 140 or a light modulation structure layer 150 in the substantially entire region of the side surface 122 while not coming into contact with the metal layer 75. For example, a front end of the second metal layer 72 and the third metal layer 73 in the z direction, i.e., an upper end reaches the same position as the upper end of the first metal layer 71 on a front side in the z direction. For example, a rear end of the second metal layer 72 and the third metal layer 73 in the z direction, i.e., a lower end reaches the same position as the lower end of the sub-carrier 120, the first metal layer 71 and the substrate 140. When seen in the y direction, the first metal layer 71 in the x direction is formed larger than the sub-carrier 120.

Like the above-mentioned configuration, an area of the first metal layer 71, i.e., a size including a plane including the x direction and the z direction is substantially the same as the area of the second metal layer 72 and the third metal layer 73, and a lower end thereof preferably reaches the same position as the lower end of the sub-carrier 120. In such a configuration, a connecting strength of the sub-carrier 120 with respect to the substrate 140 is maximally secured. That is, for example, even when each of the LD 30 and the sub-carrier 120 and an internal electrode pad corresponding to each of the LDs 30 of the plurality of internal electrodes are connected by a wire through wire bonding, release of the connection of the sub-carrier 120 and the substrate 140 can be suppressed. In addition, when a lower end of the sub-carrier 120, the first metal layer 71, the second metal layer 72, the third metal layer 73 and the substrate 140 reaches the same position, heat radiation pass from the sub-carrier 120 can be increased. Further, the area of the first metal layer 71 may be smaller than the area of the second metal layer 72 and the third metal layer 73.

In the light source unit 1000, the anti-reflection film 81 is provided between the LD 30 and the light modulation structure layer 150. For example, the anti-reflection film 81 is formed integrally with the side surface 42 of the substrate 140 and an incidence surface 151 of the light modulation structure layer 150. However, the anti-reflection film 81 may be formed only on the incidence surface 151 of the light modulation structure layer 150.

The anti-reflection film 81 is a film configured to prevent the incidence light into the light modulation structure layer 150 from being reflected in a direction opposite to a direction in which the light enters from the incidence surface 151 and increase transmissivity of the incidence light. The anti-reflection film 81 is a multi-layer film formed by alternately laminating, for example a plurality of types of dielectric substances with predetermined thicknesses according to wavelengths of the red light, green light and blue light that are incidence lights. As the above-mentioned dielectric substance, for example, titanium oxide (TiO₂), tantalum oxide (Ta₂O₅), silicon oxide (SiO₂), aluminum oxide (Al₂O₃), or the like, is exemplified.

The emission surface 31 of the LD 30 and the incidence surface 151 of the light modulation structure layer 150 are disposed at a predetermined interval. The incidence surface 151 faces the emission surface 31, and a gap 70 is provided between the emission surface 31 and the incidence surface 151 in the y direction. Since the light source unit 1000 is exposed to the air, the gap 70 is filled with the air. Since the gap 70 is filled with the same gas (air), light of each color emitted from the LD 30 can easily enter an incident portion in a state in which predetermined coupling efficiency is satisfied. When the light source unit 1000 is used for the AR glass or the VR glass, if an amount of light or the like required for the AR glass or the VR glass is considered, a size of the gap (interval) 70 in the y direction is, for example, greater than 0 µm and less than 5 µm.

### (Mach-Zehnder Type Optical Waveguide)

In the Mach-Zehnder type optical waveguide, a light beam with a wavelength and a phase is divided (demultiplexed) into a pair of two beams, each beam is given a different phase, and then combined (multiplexed). The intensity of the multiplexed light beam is changed depending on the phase difference.

The optical modulator 200 has the three Mach-Zehnder type optical waveguides 10-1, 10-2 and 10-3, which is the same number of the optical semiconductor devices 30-1, 30-2 and 30-3. The optical semiconductor devices 30-1, 30-2 and 30-3 and the Mach-Zehnder type optical waveguides 10-1, 10-2 and 10-3 are positioned to enter the Mach-Zehnder type optical waveguide to which the light emitted from the optical semiconductor device corresponds.

The Mach-Zehnder type optical waveguide 10 (10-1, 10-2, 10-3) shown in FIG. 2 has a first optical waveguide 11, a second optical waveguide 12, an incident portion 13, an exit portion 14, a demultiplexing part 15, and a multiplexing part 16. While the first optical waveguide 11 and the second optical waveguide 12 shown in FIG. 2 have a configuration that extends linearly in the x direction except the vicinity of the demultiplexing part 15 and the vicinity of the multiplexing part 16, it is not limited to such a configuration. Lengths of the first optical waveguide 11 and the second optical waveguide 12 shown in FIG. 2 are substantially the same as each other. The demultiplexing part 15 is located between the incident portion 13, the first optical waveguide 11 and the second optical waveguide 12. The incident portion 13 connects the first optical waveguide 11 and the second optical waveguide 12 via the demultiplexing part 15. The multiplexing part 16 is located between the first optical waveguide 11, the second optical waveguide 12 and the exit portion 14. The first optical waveguide 11 and the second optical waveguide 12 are connected by the exit portion 14 via the multiplexing part 16.

The Mach-Zehnder type optical waveguide 10 includes the first optical waveguide 11 and the second optical waveguide 12 that are ridges (convex shapes) protruding from a first surface 40a of a slab layer 40 formed of lithium niobate. Hereinafter, all the slab layer 40 formed of lithium niobate and ridges 11 and 12 formed of lithium niobate may be referred to as a lithium niobate film. The first surface 40a is an upper surface in a portion except the ridge of the lithium niobate film. The two ridges (a first ridge and a second ridge) protrudes from the first surface 40a in the z direction and extends along the Mach-Zehnder type optical waveguide 10. In the embodiment, the first ridge functions as the first optical waveguide 11, and the second ridge functions as the second optical waveguide 12.

A shape of an X-X cross section (a cross section perpendicular to a direction of advance of light) of the ridge (the first optical waveguide 11 and the second optical waveguide 12) shown in FIG. 3 is a rectangle, a width (W ridge) in the y direction is, for example, 0.3 µm or more and 5.0 µm or less, and a height (a protrusion height H (= Tslab-TLN) from the first surface 40a) of the ridge is, for example, 0.1 µm or more and 1.0 µm or less.

A shape of the ridge (the first optical waveguide 11 and the second optical waveguide 12) may be any shape as long as it can guide light, for example, a dome shape or a triangular shape.

The slab layer 40 formed of lithium niobate is, for example, a c-axis oriented lithium niobate film. The slab layer 40 formed of lithium niobate is, for example, an epitaxial film epitaxially grown on the substrate 140. The epitaxial film is a single crystal film, a crystal orientation of which is aligned by the underlying substrate. The epitaxial film is a film with a single crystal orientation in the z direction and a direction in the xy plane, and the crystals are aligned in all the x-axis, y-axis and z-axis directions. Whether or not it is the epitaxial film can be verified, for example, by confirming the peak intensity and the pole at an orientation position in 2θ-θ X-ray diffraction. In addition, a lithium niobate film 40 formed of lithium niobate may be a lithium niobate film provided on a Si substrate via SiO₂.

The lithium niobate is compound expressed by LixNbAyOz. A is an element other than Li, Nb and O. K, Na, Rb, Cs, Be, Mg, Ca, Sr, Ba, Ti, Zr, Hf, V, Cr, Mo, W, Fe, Co, Ni, Zn, Sc, Ce, or the like, can be exemplified as the element expressed by A. These elements may be used solely or may be used in combination of two or more. Here, x expresses a number of 0.5 or more and 1.2 or less. Here, x is, preferably, a number of 0.9 or more and 1.05 or less. Here, y expresses a number of 0 or more and 0.5 or less. Here, z expresses a number of 1.5 or more and 4.0 or less. Here, z is, preferably, a number of preferably 2.5 or more and 3.5 or less.

### (Electrode)

Electrodes 21 and 22 are electrodes configured to apply a modulation voltage Vm to each of the Mach-Zehnder type optical waveguides 10-1, 10-2 and 10-3 (hereinafter, may be simply referred to as “each of the Mach-Zehnder type optical waveguides 10”). The electrode 21 is an example of the first electrode, and the electrode 22 is an example of the second electrode. A first end 21a of the electrode 21 is connected to the second electrical signal generating device 40-2, and a second end 21b is connected to a terminating resistor 132. A first end 22a of the electrode 22 is connected to the second electrical signal generating device 40-2, and a second end 22b is connected to the terminating resistor 132.

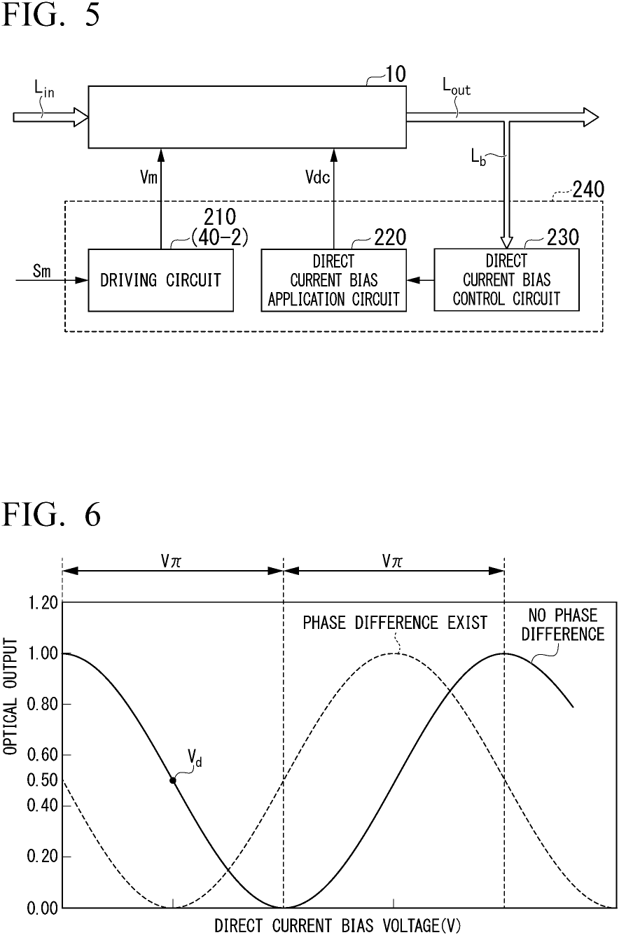

The second electrical signal generating device 40-2 is a part of a driving circuit 210 (FIG. 5) configured to apply the modulation voltage Vm to each of the Mach-Zehnder type optical waveguides 10.

The second electrical signal generating device 40-2 is connected to the synchronization signal generating device 45 together with the first electrical signal generating device 40-1, and the intensity of the light emitted from the optical modulation element 200 can be changed by synchronizing the timing of each modulation signal with the synchronization signal generated from the synchronization signal generator 45.

Electrodes 23 and 24 are electrodes configured to apply a direct current bias voltage Vdc to each of the Mach-Zehnder type optical waveguides 10. A first end 23a of the electrode 23 and a first end 24a of the electrode 24 are connected to a power supply 133. The power supply 133 is a part of a direct current bias applying circuit 220 configured to apply the direct current bias voltage Vdc to each of the Mach-Zehnder type optical waveguides 10.

In FIG. 2, a line width and line spacing of the electrode 21 and the electrode 22, which are disposed in parallel, are made wider than the actual ones to make it easier to see. For this reason, while a length (an interaction length) of a portion in which the electrode 21 and the first optical waveguide 11 overlap and a length of a portion in which the electrode 22 and the second optical waveguide 12 overlap seem to differ, these lengths (interaction lengths) are substantially the same as each other. Similarly, a length (an interaction length) of a portion in which the electrode 23 and the first optical waveguide 11 overlap and a length (an interaction length) of a portion in which the electrode 24 and the second optical waveguide 12 overlap are substantially the same as each other.

When the direct current bias voltage Vdc is superimposed on the electrodes 21 and 22, the electrodes 23 and 24 may be omitted. In addition, a grounding electrode may be provided around the electrodes 21, 22, 23 and 24.

The electrodes 21, 22, 23 and 24 are provided on the slab layer 40 formed of lithium niobate and the ridges 11 and 12 formed of lithium niobate with a buffer layer 32 sandwiched therebetween. Each of the electrodes 21 and 23 can apply an electric field to the first optical waveguide 11. Each of the electrodes 21 and 23 is located at, for example, a position overlapping the first optical waveguide 11 in the z direction when seen in a plan view. Each of the electrodes 21 and 23 is located above the first optical waveguide 11. Each of the electrodes 22 and 24 can apply an electric field to the second optical waveguide 12. Each of the electrodes 22 and 24 is located at, for example, a position overlapping the second optical waveguide 12 in the z direction when seen in a plan view. Each of the electrodes 22 and 24 is located above the second optical waveguide 12.

The buffer layer 32 is located between each of the Mach-Zehnder type optical waveguides 10 and the electrodes 21, 22, 23 and 24. A protective layer 31 and the buffer layer 32 cover and protect the ridge. In addition, the buffer layer 32 prevents the light propagating through each of the Mach-Zehnder type optical waveguides 10 from being absorbed by the electrodes 21, 22, 23 and 24. The buffer layer 32 has a refractive index lower than that of the lithium niobate film 40. The protective layer 31 and the buffer layer 32 are formed of, for example, SiInO, SiO₂, Al₂O₃, MgF₂, La₂O₃, ZnO, HfO₂, MgO, Y₂O₃, CaF₂, In₂O₃, or the like, or a mixture thereof. The protective layer 31 and the buffer layer 32 may be the same material or may be different materials. When they are different materials, they can be appropriately selected from viewpoints of improvement of DC drift, Vπ reduction, propagation loss reduction, and the like.

A size of the optical modulator 200 including the Mach-Zehnder type optical waveguide 10 is, for example, 100 mm² or less. When a size of the optical modulator 200 is 100 mm² or less, it is appropriate for the AR glass or the VR glass.

The optical modulator 200 including the Mach-Zehnder type optical waveguide 10 can be fabricated through a known method. For example, the optical modulator 200 is manufactured using a semiconductor process such as epitaxial growth, photolithography, etching, gas phase growth, metallization, and the like.

FIG. 5 is a block diagram of the optical modulator 200.

A control unit 240 of the optical modulator 200 has the driving circuit 210, the direct current bias applying circuit 220, and a direct current bias control circuit 230.

The driving circuit 210 applies the modulation voltage Vm according to a modulation signal Sm to the Mach-Zehnder type optical waveguide 10. The direct current bias applying circuit 220 applies the direct current bias voltage Vdc to the Mach-Zehnder type optical waveguide 10. The direct current bias control circuit 230 monitors output light Lout, and controls the direct current bias voltage Vd output from the direct current bias applying circuit 220. An operating point Vd, which will be described below, is controlled by adjusting the direct current bias voltage Vdc.

The optical modulator 200 converts an electrical signal into an optical signal. The optical modulator 200 modulates input light Lin emitted from the optical semiconductor device 30 and then input from the incident portion 13 of the Mach-Zehnder type optical waveguide 10 to the output light Lout. A modulation operation of the optical modulator 200 will be described.

The input light Lin emitted from the optical semiconductor device 30 and input from the incident portion 13 is demultiplexed and propagated to the first optical waveguide 11 and the second optical waveguide 12. The phase difference between the light propagating through the first optical waveguide 11 and the light propagating through the second optical waveguide 12 is zero at the point of demultiplexing.

Next, a voltage is applied to between the electrode 21 and the electrode 22. For example, differential signals having the same absolute value, opposite polarities, and phases that are not deviated from each other may be applied to the electrode 21 and the electrode 22, respectively. Refractive indices of the first optical waveguide 11 and the second optical waveguide 12 are changed by an electro-optic effect. For example, the refractive index of the first optical waveguide 11 is changed by +Δn from a reference refractive index n, and the refractive index of the second optical waveguide 12 is changed by -Δn from the reference refractive index n.

A difference between the refractive indices of the first optical waveguide 11 and the second optical waveguide 12 creates a phase difference between the light propagating through the first optical waveguide 11 and the light propagating through the second optical waveguide 12. The lights propagating through the first optical waveguide 11 and the second optical waveguide 12 are multiplexed at the multiplexing part 16 and output as the output light Lout. The output light Lout is obtained by overlapping the light propagating through the first optical waveguide 11 and the light propagating through the second optical waveguide 12. The intensity of the output light Lout is changed according to an odd number of times a phase difference of the light propagating through the first optical waveguide 11 and the light propagating through the second optical waveguide 12. In this procedure, the Mach-Zehnder type optical waveguide 10 modulates the input light Lin to the output light Lout according to the electrical signal.

The modulation voltage Vm according to the modulation signal is applied to the electrodes 21 and 22 for application of the modulation voltage of the optical modulator 200. The voltage applied to the electrodes 23 and 24 for application of the direct current bias voltage, i.e., the direct current bias voltage Vdc output from the direct current bias applying circuit 220 is controlled by the direct current bias control circuit 230. The direct current bias control circuit 230 adjusts the operating point Vd of the optical modulator 200 by controlling the direct current bias voltage Vdc. The operating point Vd is a voltage that is a center of the modulation voltage amplitude.

An optical modulation curve by each of the Mach-Zehnder type optical waveguides 10 will be described with reference to FIG. 6. FIG. 6 is a view showing a relation between the direct current bias voltage and the output for the Mach-Zehnder type optical waveguide that does not have a configuration in which a phase difference occurs between the two optical waveguides (the first optical waveguide 11 and the second optical waveguide 12) and the Mach-Zehnder type optical waveguide having a configuration in which a phase difference occurs between the two optical waveguides. A lateral axis of FIG. 6 is a direct current bias voltage applied to the electrodes 23 and 24, and a vertical axis is a standardized output from the Mach-Zehnder type optical waveguide 10. The output is standardized as “1” when a phase difference between the light propagating through the first optical waveguide 11 and the light propagating through the second optical waveguide 12 is zero. A solid line shows properties of the Mach-Zehnder type optical waveguide that does not have a configuration in which a phase difference occurs, and a broken line shows properties of the Mach-Zehnder type optical waveguide having a configuration in which a phase difference occurs.

In the Mach-Zehnder type optical waveguide that does not have the configuration in which the phase difference occurs, in a state in which the voltage is not applied (Vdc = 0), the lights of the same phase passing through the two optical waveguides interfere by the multiplexing part 16 and strengthen each other, and the output as the Mach-Zehnder type optical waveguide reaches a maximum value.

### (Adjustment Method of Light Intensity)

The light source unit according to the embodiment is configured to change the intensity of the emitted light together with current modulation to the optical semiconductor device and voltage modulation to the optical modulator.

FIG. 7 is a view schematically showing two examples of an adjustment method for changing light intensity together with current modulation to the optical semiconductor device and voltage modulation to the optical modulator. Reference sign LD in the drawings means an optical semiconductor device and reference sign LN means an optical modulator. FIG. 7 shows examples of two adjustment method of dividing rough adjustment (coarse adjustment) and fine adjustment into LD and LN and adjusting them.

Vertical axes of FIGS. 7A and 7B show intensity of light emitted from the light source unit.

FIG. 7A shows how to use the LD for adjusting a large change of the light intensity and the LN for adjusting a small change of the light intensity. That is, a rough adjustment step of the light intensity may be adjusted by the current that drives the LD, and a fine adjustment step of the light intensity may be adjusted by the voltage that operates the LN. In this case, a minimum value of the change of the light intensity by the first electrical signal generating device is greater than a minimum value of the change of the light intensity by the second electrical signal generating device.

In this case, the rough adjustment may be performed by the current, and the fine adjustment may be performed by the voltage.

Meanwhile, FIG. 7B shows how to use the LN for adjusting a large change of the light intensity and the LD for adjusting a small change of the light intensity. That is, the rough adjustment step of the light intensity may be adjusted by the voltage that operates the LN, and the fine adjustment step of the light intensity may be adjusted by the current that drives the LD. In this case, a minimum value of the change of the light intensity by the second electrical signal generating device is greater than a minimum value of the change of the light intensity by the first electrical signal generating device.

In this case, the rough adjustment may be performed by the voltage, and the fine adjustment may be performed by the current.

Since responsiveness is better when the fine adjustment is performed by the voltage, when emphasis is placed on the responsiveness, a combined use of FIG. 7A is preferable.

Meanwhile, it is possible to suppress power consumption because the current is low when the fine adjustment is performed by the current. Accordingly, when emphasis is placed on the suppression of the power consumption, a combined use of FIG. 7B is preferable.

Next, a control method of dividing rough adjustment and fine adjustment to the LD and the LN and controlling them will be described in detail with reference to the accompanying drawings.

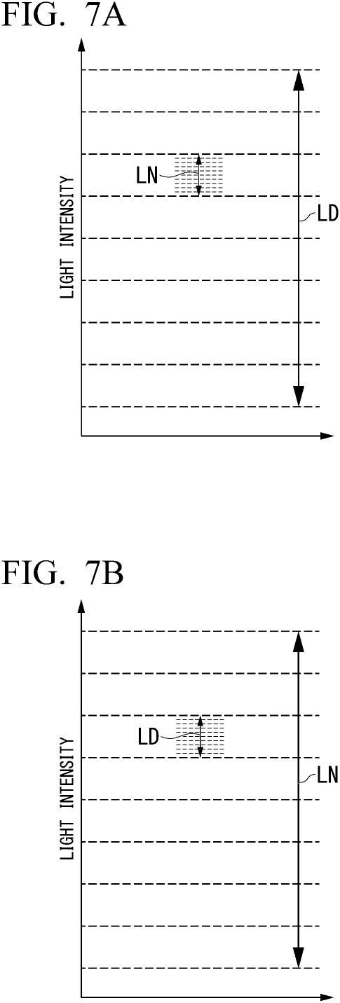

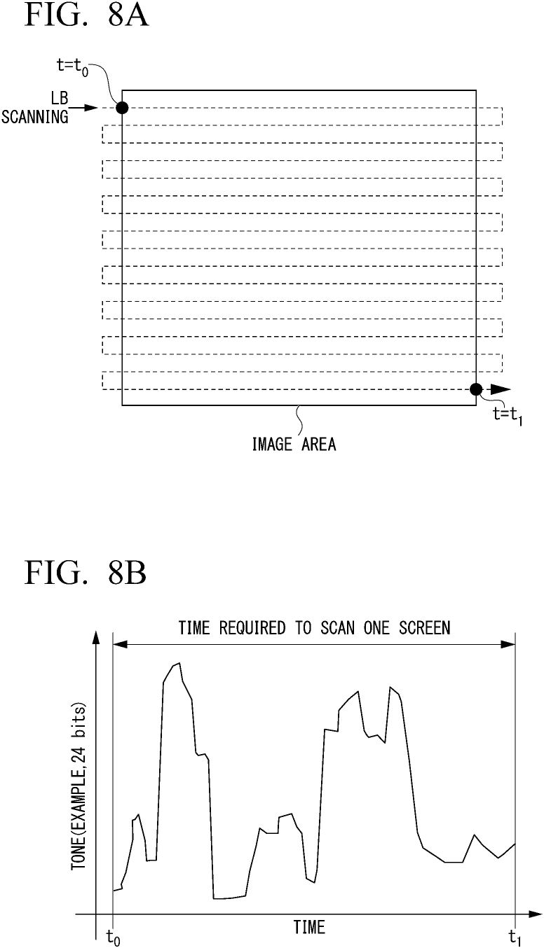

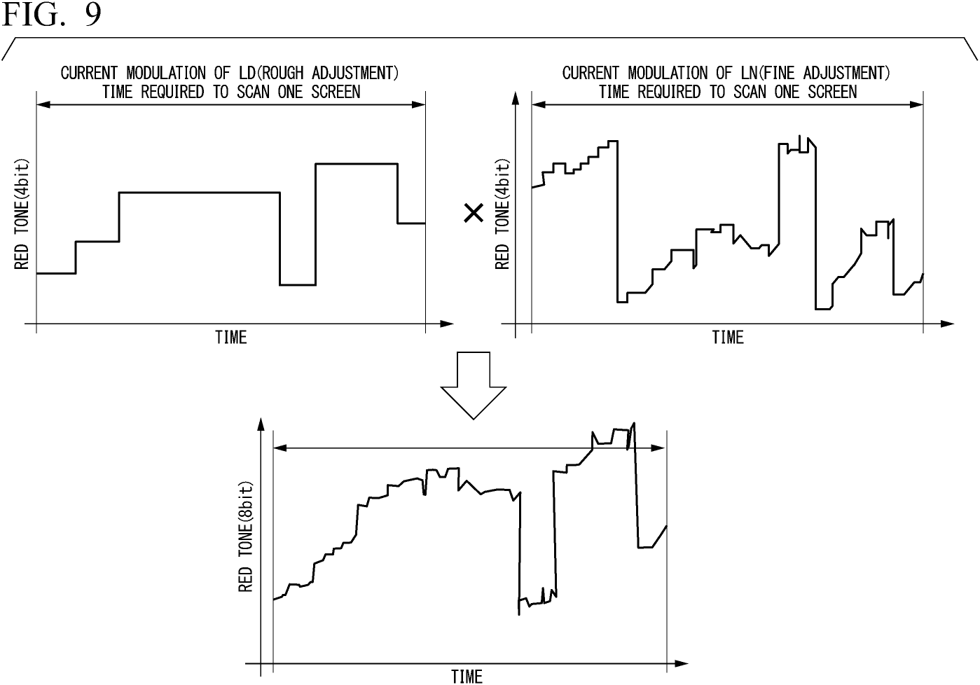

FIG. 8 and FIG. 9 are conceptual views of a control method when an image is formed by changing the light intensity (color tone) for each pixel while scanning a laser beam in an image forming device including the light source unit according to the embodiment.

As shown in FIG. 8A, a laser beam (LB) is scanned over time to cover the entire image area. As the laser beam moves through each dot (pixel) of the image over time, the color of the laser changes over time. Although it takes a predetermined time to create one image, it is recognized as one image because it is too fast for the human eye to follow. A scan speed of the laser beam is about 100 to 500 MHz in general (a speed at which all images are switched 60 times per second).

A color tone is changed by changing light intensity of three colors of red (R), green (G) and blue (B). For example, when the intensity of each color is changed with red of 8 bits, green of 8 bits and blue of 8 bits, the combined color is a tone of 24 bits (about 1677 million colors) (24-bit color method). That is, in 24-bit color, each color of RGB has 8-bit information, and each can reproduce up to 256 gradations. Combinations of reproducible colors are 256 to the third power. In this method, the image is an aggregate of pixels of 256 gradation data for each color of RGB.

FIG. 8B is a graph in which the horizontal axis represents time, and the vertical axis represents the color tone of RGB three colors.

FIG. 9 is a view schematically showing a case in which rough adjustment and fine adjustment are performed by the LD and the LN as an example of the case in which the tone is changed with 8 bits of red (R).

Each of the three graphs shown in FIG. 9 is a graph in which the horizontal axis represents time and the vertical axis represents a color tone of red. The rough adjustment is performed by current modulation of the LD with 4 bits for each pixel, the fine adjustment is performed by voltage modulation of the LN with 4 bits, and a red tone of 8 bits can be produced by the combination thereof.

A green tone and a blue tone can also be obtained for the green (G) and blue (B) in the same way. A color image of 24 bits can be obtained by combining lights of RGB.

In addition, while FIG. 9 shows the control method in which the rough adjustment is performed by the LD and the fine adjustment is performed by the LN, even in the case of the control method in which the rough adjustment is performed by the LN and the fine adjustment is performed by the LD, a color image can be obtained in the same way in principle.

A method of allocating rough adjustment and fine adjustment to LD current modulation and LN voltage modulation can be taken arbitrarily.

For example, in the case of an image with high contrast, it is preferable that the rough adjustment is performed by LD current modulation, and the fine adjustment is performed by LN voltage modulation.

Meanwhile, in the case of the image with many monotones, conversely, from the viewpoint of power consumption, it is preferable that the rough adjustment is performed by LN voltage modulation, and the fine adjustment is performed by LD current modulation.

In addition, in the case where both a high contrast portion and a high monotone portion are included in image, a switching device may be provided to switch between these adjustment methods, and image formation may be performed while switching the adjustment methods.

### (Multiplexing Part)

As shown in FIG. 10, a light source unit 1010 may have a multiplexing part 50 configured to multiplex modulation light from three Mach-Zehnder type optical waveguides in an optical modulator 200. The multiplexing part 50 multiplexes the light propagating through an output route 14E-1 of the Mach-Zehnder type optical waveguide 10-1, the light propagating through an output route 14E-2 of the Mach-Zehnder type optical waveguide 10-2, and the light propagating through an output route 14E-3 of the Mach-Zehnder type optical waveguide 10-3, and emits the light from a light exit port 150a via an output waveguide 51. Since the multiplexer is not separated from the modulator as in Patent Literature 2, the resolution, color, and the like, are improved. When the light emitted from each of the optical modulators 200-1, 200-2 and 200-3 is visible light, the multiplexing part may be referred to as a visible light multiplexing part, and a light exit port through which the light is emitted after the multiplexing may be referred to as a visible light exit port.

Referring to FIG. 1 when the light source unit 1010 does not have the multiplexing part 50, in each of the Mach-Zehnder type optical waveguides 10-1, 10-2 and 10-3 of the optical modulators 200-1, 200-2 and 200-3, the light multiplexed by each of the multiplexing parts 16 is emitted from separate light exit ports.

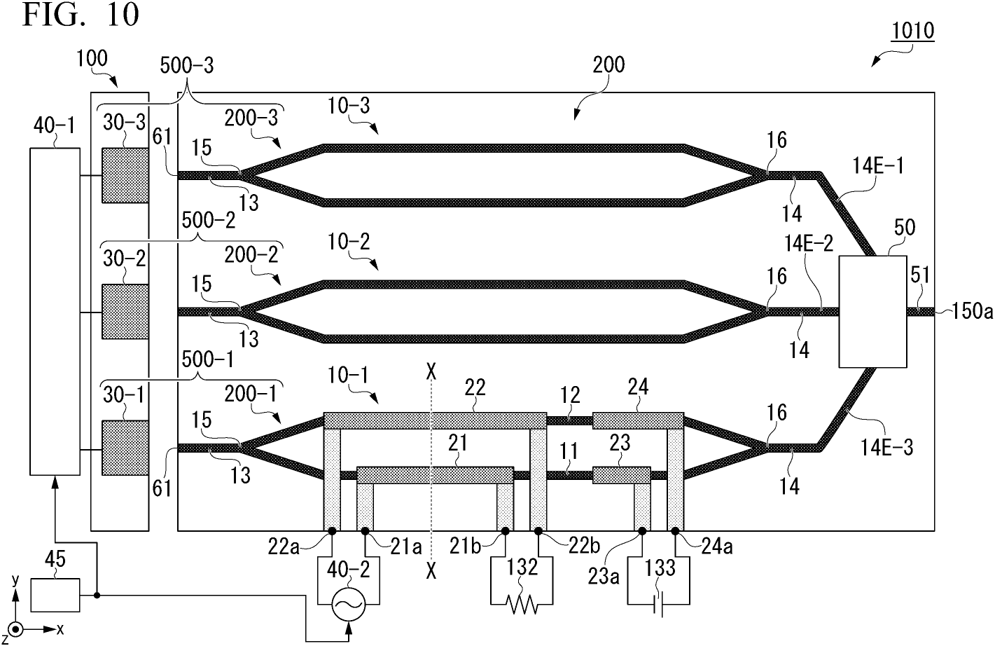

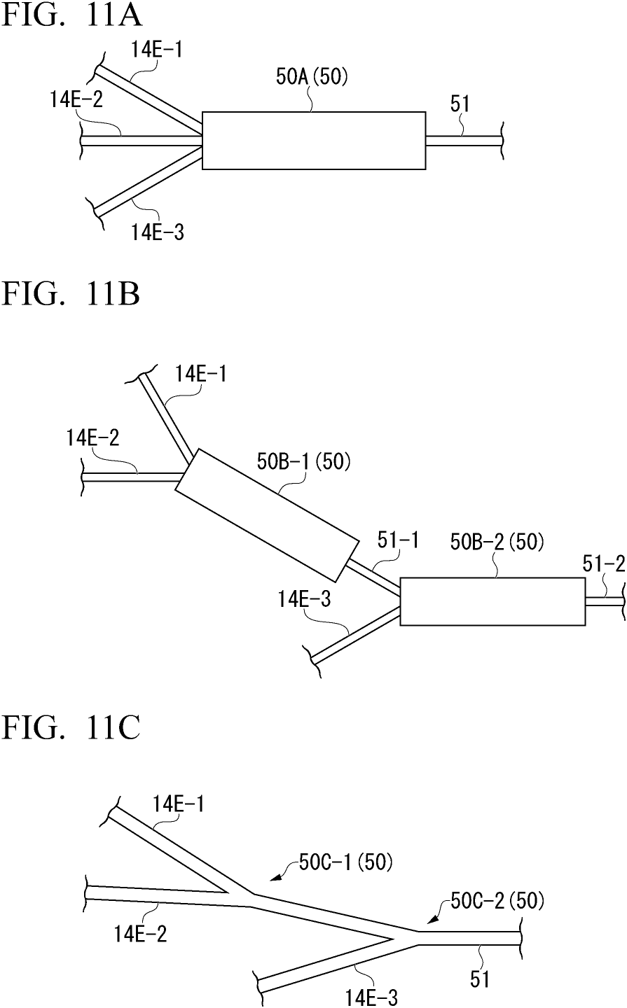

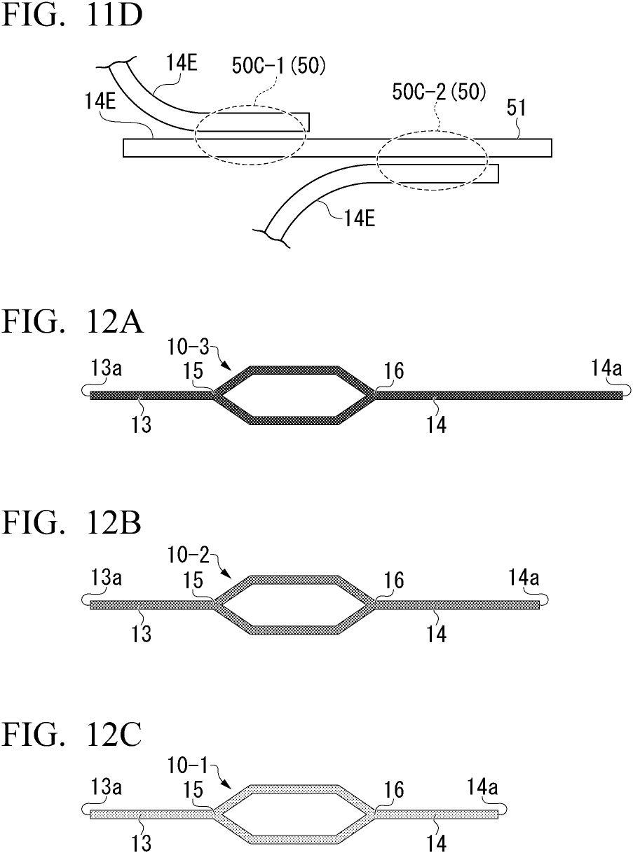

The multiplexing part 50 may be any one selected from the group consisting of a multi-mode interferometer (MMI) type multiplexer (see FIGS. 11A and 11B), a Y type multiplexer (see FIG. 11C), and a directional multiplexer (see FIG. 11D).

The multiplexing part 50 shown in FIG. 11A is a multiplexing part 50A configured to multiplex the light propagating through the output route 14E-1 of the Mach-Zehnder type optical waveguide 10-1, the light propagating through the output route 14E-2 of the Mach-Zehnder type optical waveguide 10-2, and the light propagating through the output route 14E-3 of the Mach-Zehnder type optical waveguide 10-3, and the light multiplexed is output from the multiplexing part 50A to the output waveguide 51.

In addition, the multiplexing part 50 shown in FIG. 11B is constituted by a multiplexing part 50B-1 configured to multiplex the light propagating through the output route 14E-1 of the Mach-Zehnder type optical waveguide 10-1 and the light propagating through the output route 14E-2 of the Mach-Zehnder type optical waveguide 10-2, and a multiplexing part 50B-2 configured to multiplex the multiplexed light outputting from the multiplexing part 50B-1 and the light propagating through the output route 14E-3 of the Mach-Zehnder type optical waveguide 10-3, and the light multiplexed is output from the multiplexing part 50B-2 to the output waveguide 51.

In addition, the multiplexing part 50 shown in FIG. 11C is constituted by a multiplexing part 50C-1 configured to multiplex the light propagating through the output route 14E-1 of the Mach-Zehnder type optical waveguide 10-1 and the light propagating through the output route 14E-2 of the Mach-Zehnder type optical waveguide 10-2, and a multiplexing part 50C-2 configured to multiplex the multiplexed light outputting from the multiplexing part 50C-1 and the light propagating through the output route 14E-3 of the Mach-Zehnder type optical waveguide 10-3, and the light multiplexed is output from the multiplexing part 50C-2 to the output waveguide 51.

In addition, the multiplexing part 50 shown in FIG. 11D is constituted by a directional multiplexing part 50D-1 configured to multiplex the light propagating through the output route 14E-1 of the Mach-Zehnder type optical waveguide 10-1 and the light propagating through the output route 14E-2 of the Mach-Zehnder type optical waveguide 10-2, and a directional multiplexing part 50D-2 configured to multiplex second the light propagating through the output route 14E-3 of the Mach-Zehnder type optical waveguide 10-3 and the multiplexed light, and the light multiplexed is output from the directional multiplexing part 50D-2 to the output waveguide 51.

The light source unit 1010 may have a controller (not shown) configured to control current injected into each of the three optical semiconductor devices 30 such that the peak output of each wavelength is adjusted to a predetermined ratio in the light emitted to the outside, using three Mach-Zehnder type optical waveguides 10. Since it depends on a user, application, or sensitivity of human color sense (the most sensitive to green), the combination of the currents injected into each of the three optical semiconductor elements 30 can be appropriately selected so that the peak output of each wavelength is adjusted to a predetermined ratio.

It is known that side surface roughness in an etching process is a main cause of optical loss in the optical waveguide. In addition, it is known that the optical loss by the side surface roughness is increased as the wavelength is reduced.

That is, it is known that, when the light propagating through the optical waveguide is each of blue (B), green (G) and red (R), a magnitude of the optical loss is B >G>R.

Here, the light source unit 1010 may have the three Mach-Zehnder type optical waveguides 10 configured such that a peak output of each wavelength in the light emitted to the outside through the three Mach-Zehnder type optical waveguides 10 (10-1, 10-2, 10-3) is adjusted to a predetermined ratio taking the current injected into each of the three optical semiconductor devices 30 as a fixed value. By setting the current that drives the laser to the same value for each wavelength, it is possible to use a simple driver, and as a result, a simple circuit can be realized and further miniaturization becomes possible.

If the three Mach-Zehnder type optical waveguides have the same configuration, and the optical loss by the side surface roughness does not depend on the color of the light propagating through the optical waveguide, the ratio of the optical outputs of the light of each color (or the ratio of the optical outputs of the multiplexed light when the multiplexing part is provided) becomes R: G: B = 1: 1: 1. Since the optical loss by the side surface roughness depends on the color of the light propagating through the optical waveguide, the configurations of the three Mach-Zehnder type optical waveguides are different from each other, and a difference in the optical loss by the side surface roughness can be compensated.

In addition, depending on the application, it may be desired to have a desired ratio instead of R: G: B = 1: 1: 1, but even in this case, the configurations of the three Mach-Zehnder type optical waveguides can be determined to have a predetermined ratio.

FIG. 12 to FIG. 14 show configuration examples for making the ratio of the light output of each color (or the ratio of the light output of the multiplexed light when the multiplexing part is provided) to be closer to R:G:B=1:1:1.

Among the three Mach-Zehnder optical waveguides 10 (10-1, 10-2, 10-3) shown in FIGS. 12A, 12B, and 12C, the Mach-Zehnder optical waveguide through which light with a shorter wavelength propagates has a shorter optical waveguide length from the incident end 13a to the output end 14a. For the problem specific to a ridge-type waveguide structure in which the propagation loss is increased as the wavelength becomes shorter even when the side surface roughness of the ridge is the same, the propagation loss at each wavelength can be aligned by shortening the length of the optical waveguide through which light with the shorter wavelength propagates.

With this configuration, the ratio of the light output of each color (or the ratio of the light output of the multiplexed light when the multiplexing part is provided) can approach R: G: B = 1: 1: 1.

In the configurations shown in FIGS. 12A, 12B, and 12C, while the exit portion 14 of the optical waveguide have different lengths, the incident portion 13 of the optical waveguide may have different lengths, or the incident portion 13 and the exit portion 14 may have different lengths.

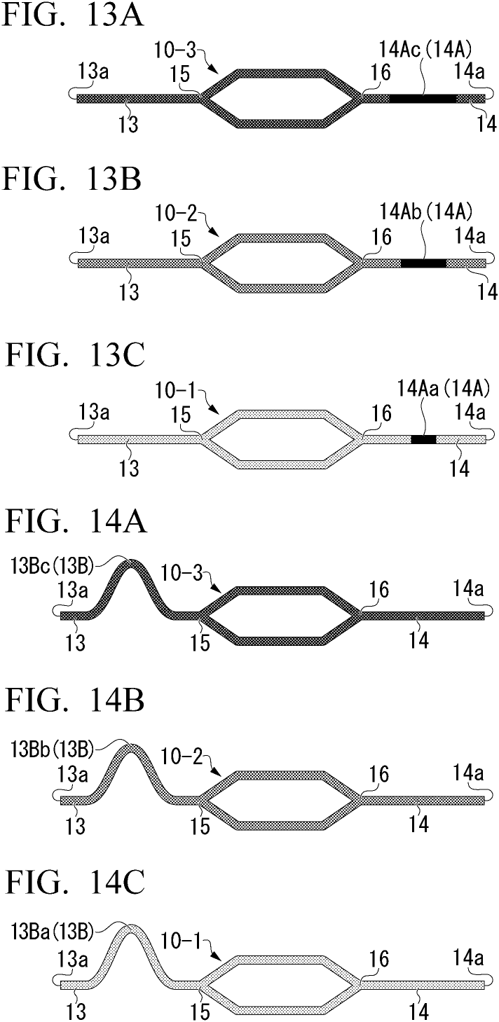

Three Mach-Zehnder optical waveguides 10 (10-1, 10-2, 10-3) shown in FIGS. 13A, 13B, and 13C have light absorption parts 14A (14Aa, 14Ab, 14Ac) formed of a material that is absorptive for the wavelength of propagating light in the optical waveguide from the incident end 13a to the output end 14a. Among the three Mach-Zehnder optical waveguides 10 (10-1, 10-2, 10-3) shown in FIGS. 13A, 13B, and 13C, the Mach-Zehnder optical waveguide through which light with a shorter wavelength propagates has a shorter light absorption parts 14A in the length direction of the optical waveguide. This configuration also makes it possible to align the propagation loss at each wavelength.

With this configuration, the ratio of the light output of each color (or the ratio of the light output of the multiplexed light when the multiplexing part is provided) can approach R: G: B = 1: 1: 1.

In the configurations shown in FIGS. 13A, 13B, and 13C, while the light absorption parts 14A are provided in the exit portion 14 of the optical waveguide, the light absorption parts 14A may be provided in the incident portion 13 of the optical waveguide, or the light absorption parts 14A may be provided both in the incident portion 13 and the exit portion 14.

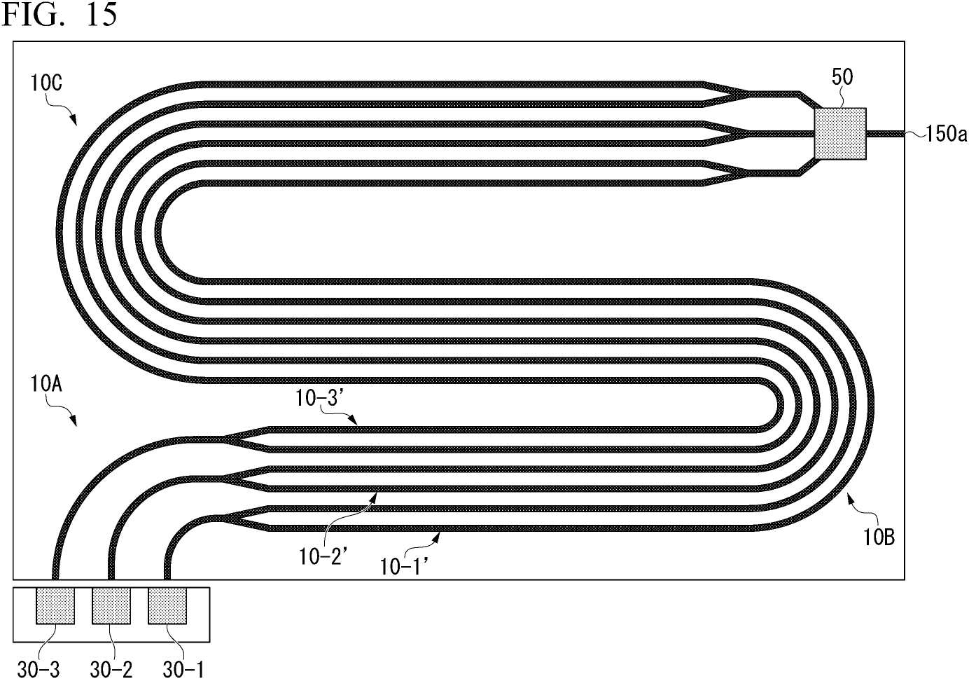

Three Mach-Zehnder optical waveguides 10 (10-1, 10-2, 10-3) shown in FIGS. 14A, 14B, and 14C have curved parts 13B (13Ba, 13Bb, 13Bc) having a curvature in the optical waveguides from the incident end 13a to the output end 14a. Among the three Mach-Zehnder optical waveguides 10 (10-1, 10-2, 10-3) shown in FIGS. 14A, 14B, and 14C, the Mach-Zehnder optical waveguide through which light with a shorter wavelength propagates has a curved part 13B having a larger curvature and a shorter length thereof. This configuration also makes it possible to align the propagation loss at each wavelength.

With this configuration, the ratio of the light output of each color (or the ratio of the light output of the multiplexed light when the multiplexing part is provided) can approach R: G: B = 1: 1: 1.

In the configurations shown in FIGS. 14A, 14B, and 14C, while the Mach-Zehnder optical waveguide through which light with a shorter wavelength propagates has a curved part 13B having a larger curvature and a shorter length thereof, the Mach-Zehnder optical waveguide through which light with a shorter wavelength propagates may have a curved part 13B having a larger curvature or may have a curved part 13B having a shorter length thereof.

In the configurations shown in FIGS. 14A, 14B, and 14C, while the curved parts 13B are provided in the incident portion 13, the curved parts 13B may be provided in the exit portion 14, and the curved parts 13B may be provided both in the incident portion 13 and the exit portion 14.

For the three Mach-Zehnder type optical waveguides 10 (10-1, 10-2, and 10-3), maximum values of the optical outputs may have the same intensity.

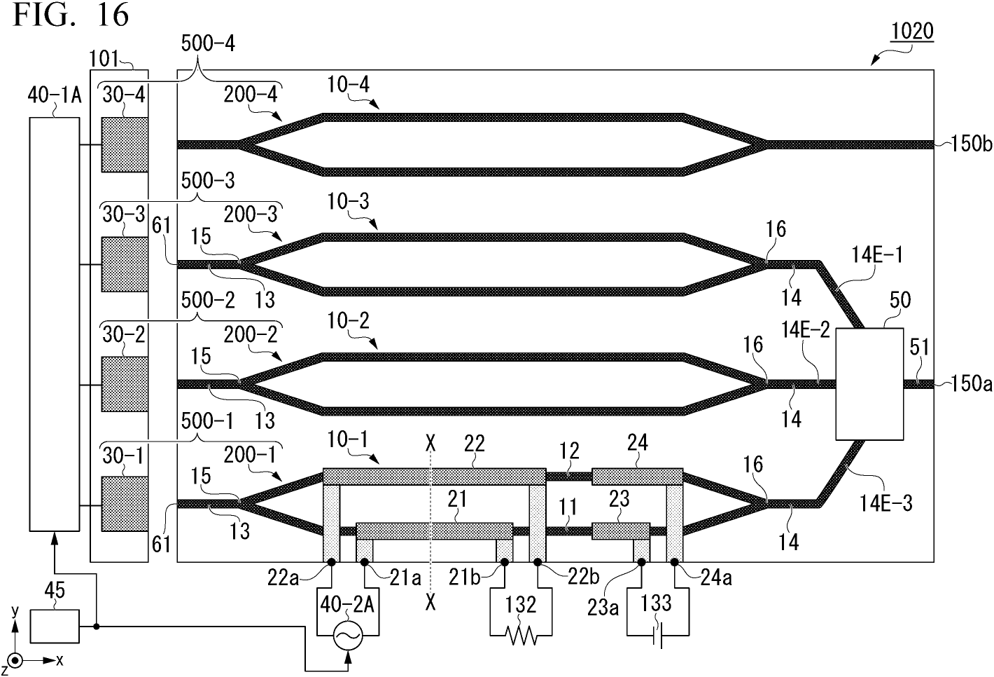

As shown in FIG. 15, each of Mach-Zehnder type optical waveguides 10′ (10-1′, 10-2′, 10-3′) may have curved parts 10A, 10B and 10C. The curved parts may be included in any of portions of two mode waveguides 11 and 12 (portions shown by reference sign 10B and reference sign 10C), an incident portion (a portion shown by reference sign 10A), or an exit portion in the Mach-Zehnder type optical waveguide.

In the configuration of the optical waveguide obtained by processing the single crystal lithium niobate thin film formed on the substrate in the convex shape, a high refractive index difference can be applied to between the core area (single crystal lithium niobate thin film) and the cladding area (the substrate, and side surface material and upper surface material of the optical waveguide), and the optical waveguide can be curved with a large curvature. The size in the longitudinal direction can be reduced by the curving. In addition, since an interaction length can be increased while keeping the size in the longitudinal direction small, a driving voltage can be lowered.

FIG. 16 is a plan view schematically showing a light source unit according to another embodiment.

A light source unit 1020 shown in FIG. 16 differs from the light source unit 1000 shown in FIG. 2 or the light source unit 1010 shown in FIG. 10 in that an optical module 500-4 having an optical semiconductor device 30-4 configured to emit near infrared light is further provided, and a total of four optical modules are provided.

The light source unit 1020 shown in FIG. 16 has an optical module 500-1 in which the optical semiconductor device 30-1 emitting visible light and the optical modulator 200-1 are optically connected, an optical module 500-2 in which the optical semiconductor device 30-2 emitting visible light and the optical modulator 200-2 are optically connected, an optical module 500-3 in which the optical semiconductor device 30-3 emitting visible light and the optical modulator 200-3 are optically connected, and an optical module 500-4 in which the optical semiconductor device 30-4 emitting near infrared light and the optical modulator 200-4 are optically connected.

While the light source unit 1020 shown in FIG. 16 includes one optical module configured to emit near infrared light, the number of the optical module configured to emit near infrared light is not limited and a plurality of optical modules may be provided. In addition, when the plurality of optical modules configured to emit near infrared light are provided, peak wavelengths of the near infrared lights emitted from the optical modules may be different from each other.

The optical module 500-1, the optical module 500-2, the optical module 500-3, and the optical module 500-4 can be independently controlled. That is, each of the optical semiconductor device 30-1, the optical semiconductor device 30-2, the optical semiconductor device 30-3, and the optical semiconductor device 30-4 can control current modulation independently driven by the first electrical signal generating device 40-1A. In addition, each of the optical modulator 200-1, the optical modulator 200-2, and the optical modulator 200-3 can control voltage modulation independently operated by the second electrical signal generating device 40-2A. Further, in the optical module of each of the optical module 500-1, the optical module 500-2, the optical module 500-3, and the optical module 500-4, the intensity of the light modulated by independently matching the timing by the first electrical signal generating device 40-1A and the second electrical signal generating device 40-2A, which are synchronizably connected and emitted from each of the optical modulators can be changed.

Further, in FIG. 16, in order to make the features easier to see, the electrode configured to apply an electric field to the Mach-Zehnder type optical waveguide is drawn only for the optical modulator 200-1, and not for the optical modulator 200-2, the optical modulator 200-3 or the optical modulator 200-4.

In the light source unit 1020 shown in FIG. 16, the optical module 500-1 may be referred to as a blue optical module having the optical semiconductor device 30-1 with a peak wavelength of 380 nm to 500 nm, the optical module 500-2 may be referred to as a green optical module having the optical semiconductor device 30-2 with a peak wavelength of 500 nm to 600 nm, and the optical module 500-3 may be referred to as a red optical module having the optical semiconductor device 30-2 with a peak wavelength of 600 nm to 830 nm.

In this case, blue light from the blue optical module 500-1, green light from the green optical module 500-2, and red light from the red optical module 500-3 are multiplexed by the visible light multiplexing part 50, and the multiplexed visible light is emitted from the visible light exit port 150a. In addition, near infrared light from the optical module 500-4 is emitted from another light exit port (near infrared light exit port) 150b.

The near infrared light emitted from the light exit port 150b can be used as light for performing eye-tracking in a smart glass in which the light source unit 1020 is mounted. In this case, the near infrared light can be used without performing current modulation and voltage modulation.

While the light source unit 1020 shown in FIG. 16 includes separately a light exit port for visible light and a light exit port for near infrared light and is configured to emit visible light and near infrared light from separate light exit ports, the light source unit may include a multiplexing part configured to multiplex visible light and near infrared light and may be configured to emit the visible light and the near infrared light from one light exit port.

### (Stray Light Propagation Prevention Part)

In the optical modulator 200, a portion of other than the Mach-Zehnder type optical waveguide may have a groove portion reaching to a position deeper than a surface of the substrate on which the Mach-Zehnder type optical waveguide is formed. Such a groove portion functions as a stray light propagation prevention part, and can prevent stray light from propagating through the portion including the substrate and from emitting to the outside. A light absorption layer may be provided on an at least a bottom surface and a side surface of the groove portion. The light absorption layer can absorb the stray light and prevent it from propagating through the portion including the substrate.

Although the optical modulator 200 can be miniaturized, miniaturization makes it more likely that components of light that is not coupled to the optical waveguide occurs in the alignment step of aligning the optical axis. Such components of light propagates through the portion other than the optical waveguide in the optical modulator 200, and after multiple reflections on the end surface, a part thereof is input into a light detector, i.e., stray light easily occurs. The stray light propagating through the optical modulator 200 inhibits alignment of the light detector, and causes an increase in connecting loss or poor connections. In particular, when the visible light is used as the light source, since the optical waveguide is small, an influence due to the stray light is large. For this reason, it is preferable that the optical modulator includes the stray light propagation prevention parts having the groove portions and the light absorption layer on their surface.

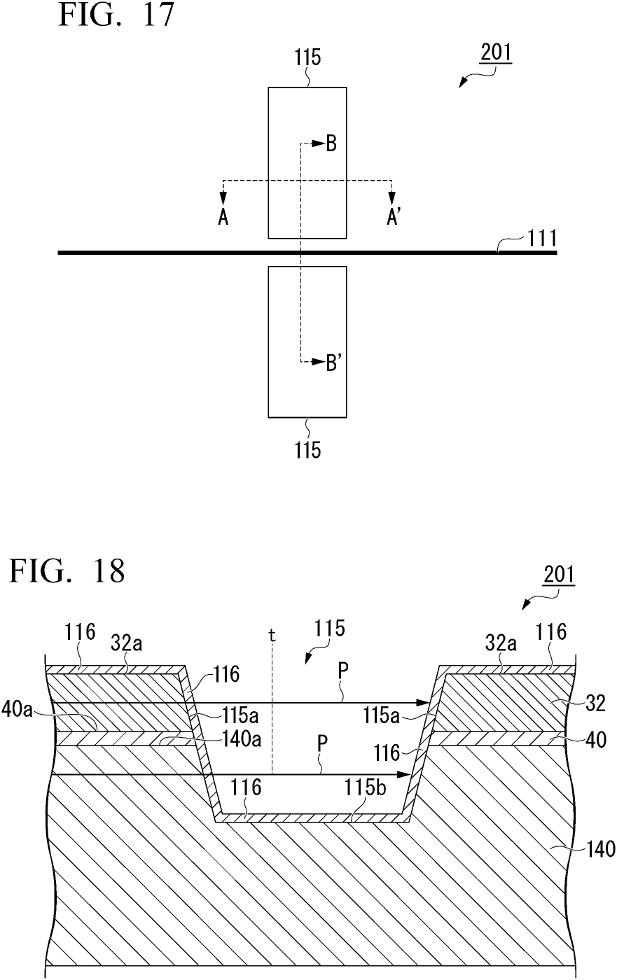

The stray light propagation prevention part will be described by taking a configuration with a groove portion 115 in the vicinity of an optical waveguide 11 as an example. FIG. 17 is a plan view schematically showing such a configuration. FIG. 18 is a cross-sectional view along line A-A′ of FIG. 17. FIG. 19 is a cross-sectional view along line B-B′ of FIG. 17.

As shown in FIG. 17, the groove portions 115 are formed in an optical modulator 201 in the vicinity of the optical waveguide 111. The groove portions 115 are formed at parts of both sides of the optical waveguide 111. The groove portions 115 are formed to have a rectangular shape, for example, an oblong shape when one surface of the substrate is viewed in a plan view. In addition, the groove portions 115 are formed to have an inverted-trapezoidal cross-sectional shape of the light source unit 1000 in a thickness direction (stacking direction) t, and side surfaces 115a of the groove portions 115 are formed to be inclined surfaces inclined with respect to the thickness direction t.

The groove portions 115 are formed to reach a position deeper than the one surface 11a of the substrate 140 toward the substrate 140 from a surface 32a of the buffer layer 32. That is, bottom surfaces 115b of the groove portions 115 are formed at positions caved inside the substrate from the one surface 140a of the substrate 140, and the substrate 140 has a shape recessed in the thickness direction t at parts where these groove portions 115 are formed.

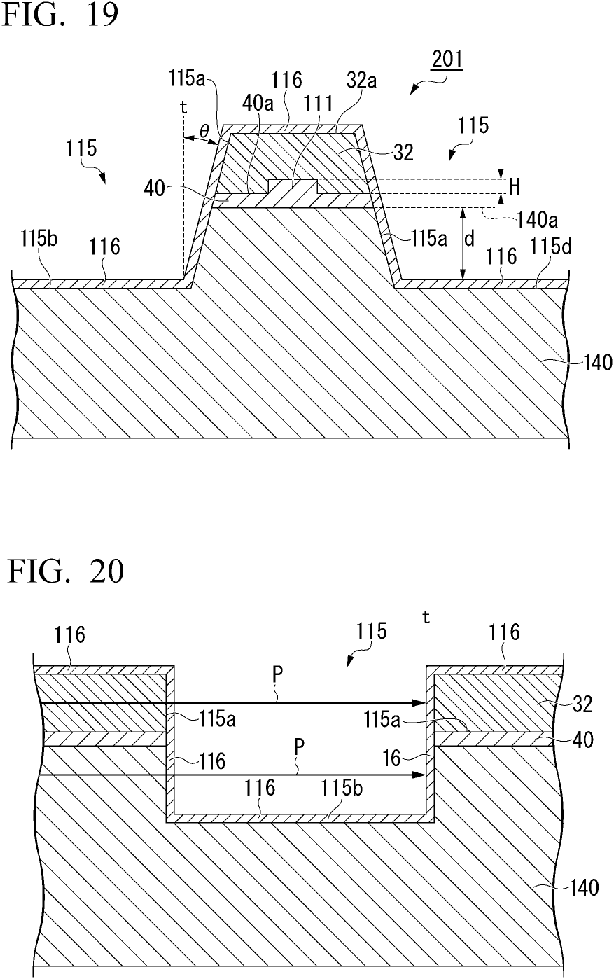

In the present embodiment, the side surfaces 115a of the groove portions 115 are inclined surfaces inclined at a predetermined inclination angle θ with respect to the thickness direction t. However, for example, as illustrated in FIG. 20, the groove portions 115 can also be formed to have a rectangular shape as a cross-sectional shape of the light source unit 1000 in the thickness direction t so that the side surfaces 115a of the groove portions 115 are formed to be perpendicular surfaces in the thickness direction t.

Depths of the groove portions 115 at the substrate 140 parts caved in along the thickness direction t from the one surface 140a of the substrate 140, that is, gaps d between the one surface 140a of the substrate 140 and the bottom surfaces of the groove portions 115 may be set in accordance with the wavelength of light propagated through the optical waveguide 111. That is, the gaps d may be set to be equal to or larger than half the wavelength of light propagated through the optical waveguide 111. For example, when the wavelength of light propagated through the optical waveguide 111 is 520 nm, the groove portions 115 may be formed such that the gaps d become equal to or larger than 260 nm.

Between such two groove portions 115, the substrate 140, the waveguide layer 12 in which the optical waveguide 111 is formed in a ridge shape, and the buffer layer 32 are formed such that they extend in a dam shape with a narrow width from the bottom surface 115b of the groove portion 115.

A light absorption layer 116 covering the bottom surface 115b and the side surface 115a of the groove portion 115 is formed in this groove portion 115. In the present embodiment, the light absorption layer 116 is formed to not only cover the bottom surface 115b and the side surface 115a of the groove portion 115 but also cover the surface 32a of the buffer layer 32. The light absorption layer 116 may have a structure not covering the surface 32a of the buffer layer 32.

The light absorption layer 116 is constituted using a material absorbing light propagated through the optical waveguide 111. A material for constituting the light absorption layer 116 is selected in accordance with the wavelength of light propagated through the optical waveguide 111. For example, when light propagated through the optical waveguide 111 is visible light, it is possible to use a material capable of absorbing and blocking light in a visible wavelength range, for example, a resin material including a visible light absorbing dye such as C, Si, Ge, a cyanine compound, an azo compound, a diphenylmethane compounds, or a triphenylmethane compound; a semiconductor such as In or Ga; oxide or nitride consisting of Ti, Ni, Cr, Fe, Nb, Ta, Zn, W, or Mo, or an alloy of these; or the like. In addition, for example, when light propagated through the optical waveguide 111 is infrared light, it is possible to use a material capable of absorbing and blocking light in an infrared wavelength range, for example, a resin material or the like including an infrared light absorbing dye such as a cyanine compound, a dimonium compound, or a squarylium compound.

The light absorption layer 116 need only be formed to have a thickness, for example, capable of absorbing 50% or more of stray light P incident on the light absorption layer 116. Accordingly, the stray light P is absorbed while passing through the light absorption layer 116 formed on one side surface 115a of the groove portion 115 and the light absorption layer 116 formed on the other side surface 115a.

As in the present embodiment, the light absorption layer 116 can also be formed as illustrated in FIG. 21, for example, in addition to being formed on the bottom surface 115b and the side surface 115a of the groove portion 115 with a predetermined thickness. In FIG. 21, the light absorption layer 116 is formed such that the entire groove portion 115 including the bottom surface 115b and the side surface 115a is filled therewith. Due to such a constitution, the stray light P can be more reliably absorbed.

According to the optical modulator 201 of the embodiment having such a constitution, for example, during an alignment step in which optical axes are aligned between the light source (light emitter) S introducing light into the optical waveguide 111 and the input end portion IN of the optical waveguide 111, a component of light which is not coupled to the optical waveguide 111 may be generated. Such a component of light which is not coupled to the optical waveguide 111 becomes the stray light P propagated through parts other than the optical waveguide 111 inside the light source unit 100, for example, a part near the one surface 140a side of the substrate 140 and the buffer layer 32. In the optical modulator 201 of the present embodiment, if such stray light P reaches a formation position of the groove portion 115, the stray light P is absorbed by the light absorption layer 116.

Particularly, since the groove portions 115 are formed at positions deeper than the one surface 140a of the substrate 140 in the thickness direction t, the stray light P propagated through a part near the one surface 140a side of the substrate 140 are reliably absorbed by the light absorption layers 116 formed therein.

Since the stray light P is absorbed and blocked by such groove portions 115 and the light absorption layers 116 formed in these groove portions 115, the stray light P is not input to a photodetector (not illustrated) disposed in the output end portion OUT of the optical waveguide 111. Accordingly, in the alignment step, it is possible to prevent hindrance to alignment of the photodetector and occurrence of increase in connection loss and poor connection.

The stray light P can also be blocked by appropriately setting the inclination angles θ of the side surfaces 115a of the groove portions 115. For example, in a case in which the stray light P is incident toward a space of the groove portion 115 (air layer) from the buffer layer 32, if the refractive index of air is 1 and the refractive index of the buffer layer 32 is approximately 3.5, when the incident angle of the stray light P in an interface between the buffer layer 32 and air is approximately 15° or larger, total reflection occurs in the interface due to the difference between the refractive indices thereof. The incident angle of the stray light P with respect to the side surface 115a of the groove portion 115 becomes 15° or larger when the inclination angle θ of the side surface 115a is ±15° or larger. At this time, the reflection coefficient of the stray light P becomes 100%, and the stray light P is completely emitted to the upper side or the lower side of the light source unit 1000 and is eliminated.

Next, an optical modulator 202 of the other embodiment will be described. In the following embodiment, the same numbers are applied to constitutions similar to those of the embodiment described above, and duplicate description thereof will be omitted.

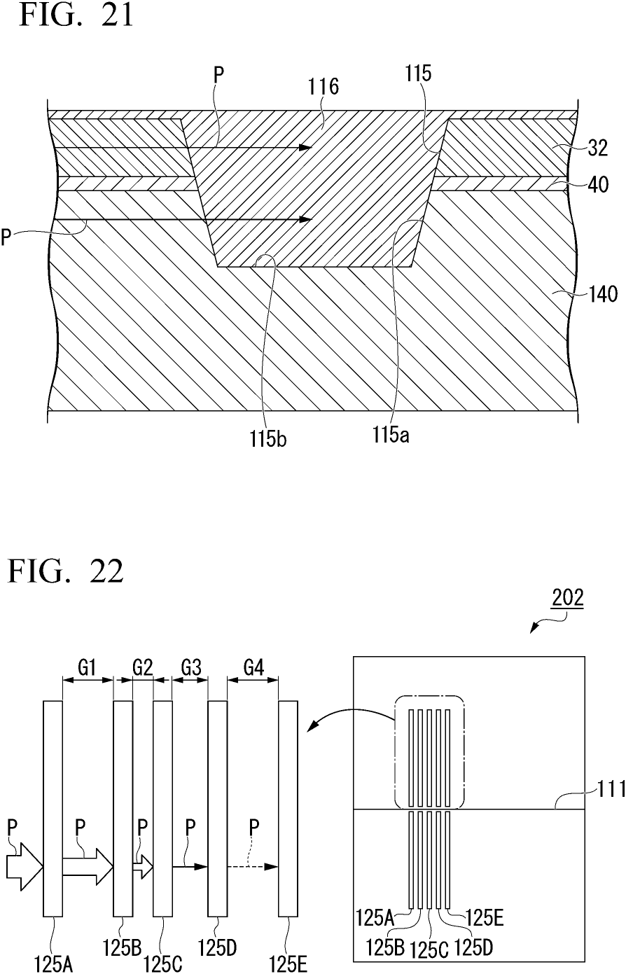

FIG. 22 is a plan view of the optical modulator 202 according to the embodiment when viewed from above.

In the optical modulator 202 of the present embodiment, a plurality of groove portions (five in the present embodiment) 125A, 125B, 125C, 125D, and 125E are formed on each of both sides of the optical waveguide 111 in an extending direction of the optical waveguide 111 with a space therebetween. Each of the groove portions 125A to 125E is formed to have the same rectangular shape (oblong shape) as each other when the one surface 140a of the substrate 140 (refer to FIG. 19) is viewed in a plan view.

In this embodiment, the groove portions 125A to 125E are formed such that all a gap G1 between the groove portion 125A and the groove portion 125B, a gap G2 between the groove portion 125B and the groove portion 125C, a gap G3 between the groove portion 125C and the groove portion 125D, and a gap G4 between the groove portion 125D and the groove portion 125E differ from each other.

Furthermore, the groove portions are formed such that the sum of the gap between arbitrary groove portions of the groove portions 125A to 125E differs from the sum of the gap between different arbitrary groove portions of the groove portions 125A to 125E. For example, the value of the sum of the gap G1 and the gap G3 differs from that of the gap G2 and the gap G4. In addition, for example, the value of the sum of the gap G2, the gap G3, and the gap G4 differs from that of the gap G1, the gap G3, and the gap G4.

If the plurality of groove portions 125A to 125E are regularly arranged at equal gaps therebetween, there is concern that reflected stray light may be regularly intensified. However, stray light can be prevented from being regularly reflected and synergically intensified by varying the gap between groove portions of the groove portions 125A to 125E adjacent to each other as in the present embodiment, and the stray light P can be reliably absorbed and blocked by the plurality of groove portions 125A to 125E and the light absorption layer 116 covering these.

Next, an optical modulator 203 of the other embodiment will be described. In the following embodiment, the same numbers are applied to constitutions similar to those of the embodiment described above, and duplicate description thereof will be omitted.

FIG. 23 is a plan view of the optical modulator 203 of the other embodiment when viewed from above.

In the optical modulator 203 of the present embodiment, a plurality of groove portions (five in the present embodiment) 135A, 135B, 135C, 135D, and 135E are formed on each of both sides of the optical waveguide 111 in the extending direction of the optical waveguide 111 with a space therebetween. Each of the groove portions 135A to 135E is formed to have a rectangular shape (oblong shape) when the one surface 140a of the substrate 140 (refer to FIG. 19) is viewed in a plan view.

In this embodiment, the groove portions 135A to 135E are formed such that all widths W1 to W5 of the groove portions 135A to the groove portions 135E in the extending direction of the optical waveguide 111 differ from each other.

Furthermore, the groove portions 135A to 135E are formed such that the sum of the widths of the widths W1 to W5 of arbitrary groove portions of the groove portions 135A to 135E differs from the sum of the widths of the widths W1 to W5 of different arbitrary groove portions of the groove portions 135A to 135E. For example, the value of the sum of the width W1 and the width W3 differs from that of the width W2 and the width W4. In addition, for example, the value of the sum of the width W1, the width W3, and the width W5 differs from that of the width W1, the width W2, and the width W4.

If the widths of the plurality of groove portions 135A to 135E are equivalent to each other, there is concern that stray light may be regularly reflected and intensified. However, stray light can be prevented from being regularly reflected and synergically intensified by varying the widths of the groove portions 135A to 135E adjacent to each other as in the present embodiment, and the stray light P can be reliably absorbed and blocked by the plurality of groove portions 135A to 135E and the light absorption layer 116 covering these.

Next, an optical modulator 204 of the other embodiment of the present disclosure will be described. In the following embodiment, the same numbers are applied to constitutions similar to those of the embodiment described above, and duplicate description thereof will be omitted.

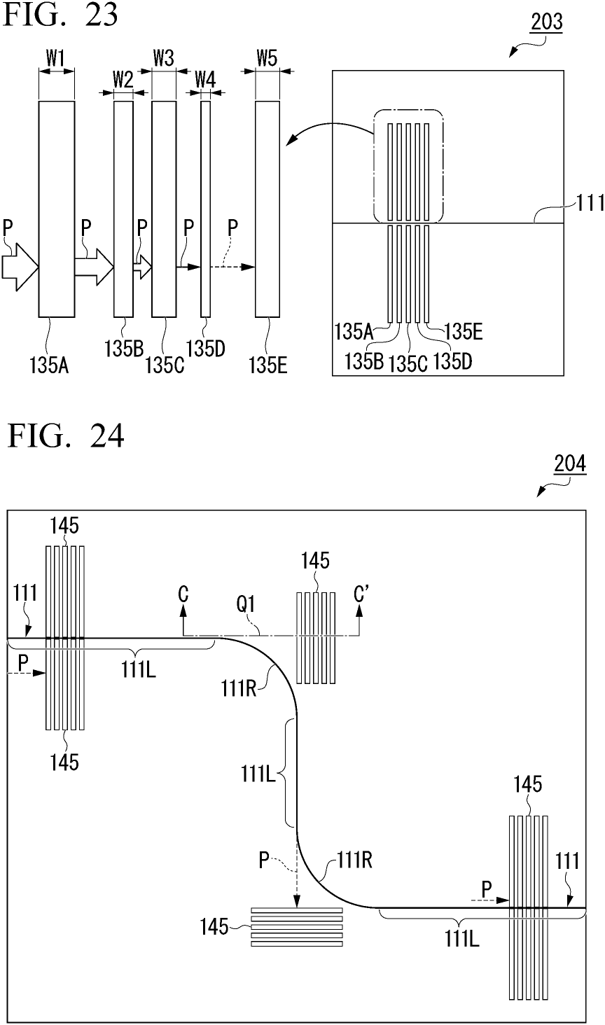

FIG. 24 is a plan view of an optical modulator 204 of the embodiment of the present disclosure when viewed from above. FIG. 25 is a cross-sectional view cut along line C-C′ in FIG. 24.

In optical modulator 204 of the present embodiment, the optical waveguide 111 is constituted of straight portions 111L extending in a straight shape, and curved portions 111R curved from these straight portions 111L.

Further, in the straight portions 111L at two locations, a plurality of groove portions 145, 145, and so on are formed across both sides of each of the straight portions 111L, and the inner surfaces (side surfaces and bottom surfaces) of these groove portions 145 are covered by the light absorption layer 116.

Moreover, a plurality of groove portions 145, 145, and so on are also formed on a virtual extension line Q1 of a straight portion L1 extending in a direction branching off from the curve direction of the curved portion 111R at a connection part between the straight portion L1 of the optical waveguide 111 and the curved portion 111R, and the inner surfaces (side surfaces and bottom surfaces) of these groove portions 145 are covered by the light absorption layer 116.

According to the optical modulator 204 of the above-mentioned configuration, when the light propagating through the optical waveguide 111 enters the curved part 111R from the linear section 111L, the stray light P propagating through the substrate 140 or the buffer layer 32 goes straight as it is without curving at the formation position of the curved part 111R with respect to the cover along the curved part 111R. Then, the stray light P that goes straight is absorbed by the light absorption layer 116 that covers the plurality of groove sections 145, 145... formed on the virtual extension line Q1 of the linear section 111L. Accordingly, according to the optical modulator 204 of the embodiment, the stray light P that goes straight at a formation position of a curved part 11R of the optical waveguide 111 can prohibit alignment of the light detector and prevent occurrence of an increase in connecting loss or occurrence of poor connection in, for example, the alignment process, without emission to the outside of the optical modulator 204.

Next, the optical modulator 205 of the other embodiment will be described. Further, in the following embodiment, the same components as the above-mentioned optical modulator 204 are designated by the same reference signs and overlapping description thereof will be omitted.

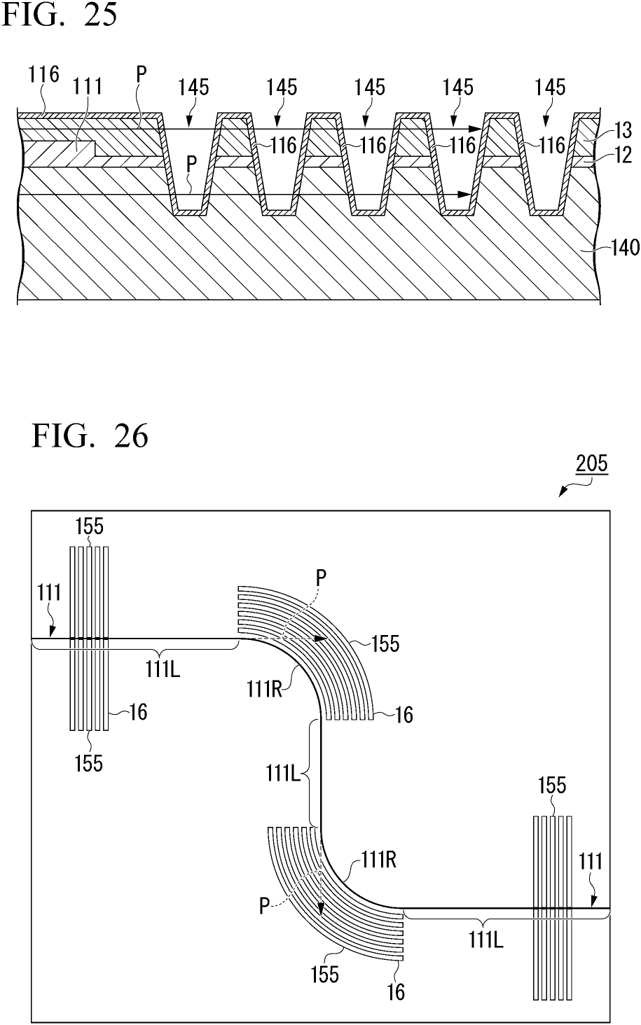

FIG. 26 is a plan view of the optical modulator 205 from above.

In the optical modulator 205 of the present embodiment, the optical waveguide 111 is constituted of the straight portions 111L extending in a straight shape, and the curved portions 111R curved from these straight portions 111L.

Further, in the straight portions 111L at two locations, a plurality of groove portions 145, 145, and so on are formed across both sides of each of the straight portions 111L, and the inner surfaces (side surfaces and bottom surfaces) of these groove portion 145 are covered by the light absorption layer 116.

Further, the plurality of curved groove sections 155, 155... are formed on a curved outer circumference of the curved part 111R of the optical waveguide 111, and the inner surfaces (side surfaces, bottom surfaces) of the groove sections 155 are covered with the light absorption layer 116.

According to the optical modulator 205 having such a constitution, when light propagated through the optical waveguide 111 enters the curved portion 111R from the straight portion L1, the light is curved along this curved portion 111R. In contrast, the stray light P propagated through the substrate 140 or the buffer layer 32 travels forward as it is without being curved at the formation position of the curved portion 111R. Further, this stray light P which has traveled forward is absorbed by the plurality of curved groove portions 155, 155, and so on formed along the curved outer circumferences of the curved portions 111R and the light absorption layer 116 covering these.

As an example, according to the constitution of the present embodiment, for example, when the wavelength of light being incident on the optical waveguide 111 is set to 520 nm and the light absorption layer 116 is formed using a Si film, since the light absorption coefficient of Si is 1.35×10⁵ cm⁻¹, even if the thickness of the light absorption layer 116 is 100 nm, five groove portions 155 are arranged so that stray light can be attenuated up to approximately 26% of the intensity before being incident thereon while the stray light is transmitted through all the light absorption layer 116 formed in each of the five groove portions 155.

Therefore, according to the optical modulator 205 of the present embodiment, the stray light P which has traveled forward at the formation position of the curved portions 111R of the optical waveguide 111 is not emitted to the outside of the optical modulator 205, and for example, in the alignment step, it is possible to prevent hindrance to alignment of the photodetector and occurrence of increase in connection loss and poor connection.

### (Optical Engine)

In the specification, the optical engine is a device including a plurality of light sources, an optical system including a multiplexing part configured to multiplex a plurality of lights emitted from the plurality of light source to a single beam, an optical scanning mirror configured to reflect the light emitted from the optical system by changing an angle thereof to display an image, and a control device configured to control the optical scanning mirror.

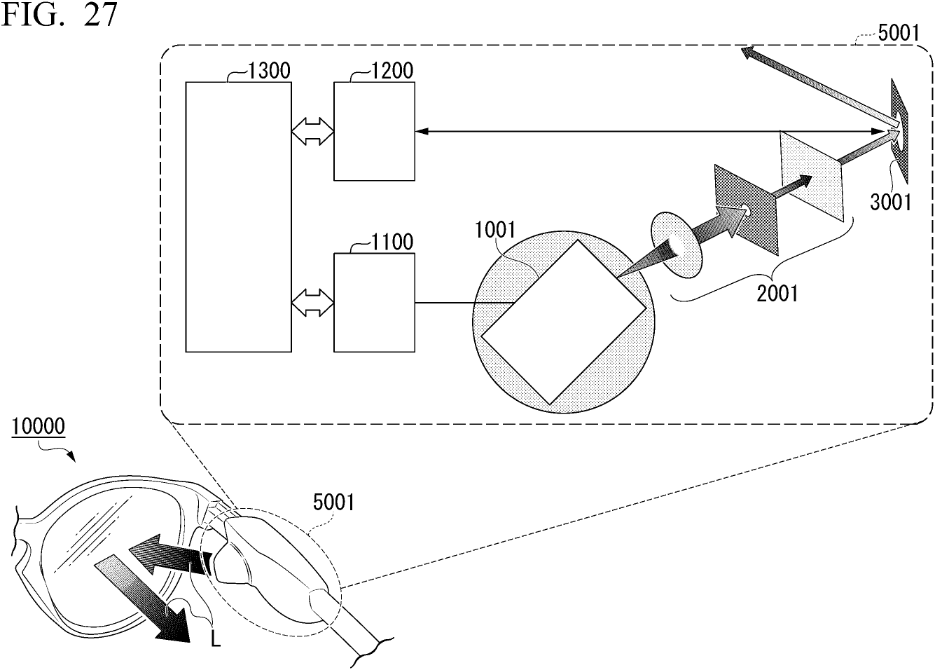

FIG. 27 is a conceptual view for describing an optical engine 5001 according to the embodiment. As shown, the optical engine 5001 is mounted on a frame 10010 of spectacles 10000. Reference sign L designates image display light.

The optical engine 5001 has a light source unit 1001 and an optical scanning mirror 3001. As the light source unit 1001 included in the optical engine 5001, the light source unit according to the above-mentioned embodiment is used.

As the light source unit 1001, a unit including a multiplexing part having three optical modules of RGB of the red optical module, the green optical module and the blue optical module and configured to multiplex the RGB lights emitted from the RGB optical modules to a single beam can be used.

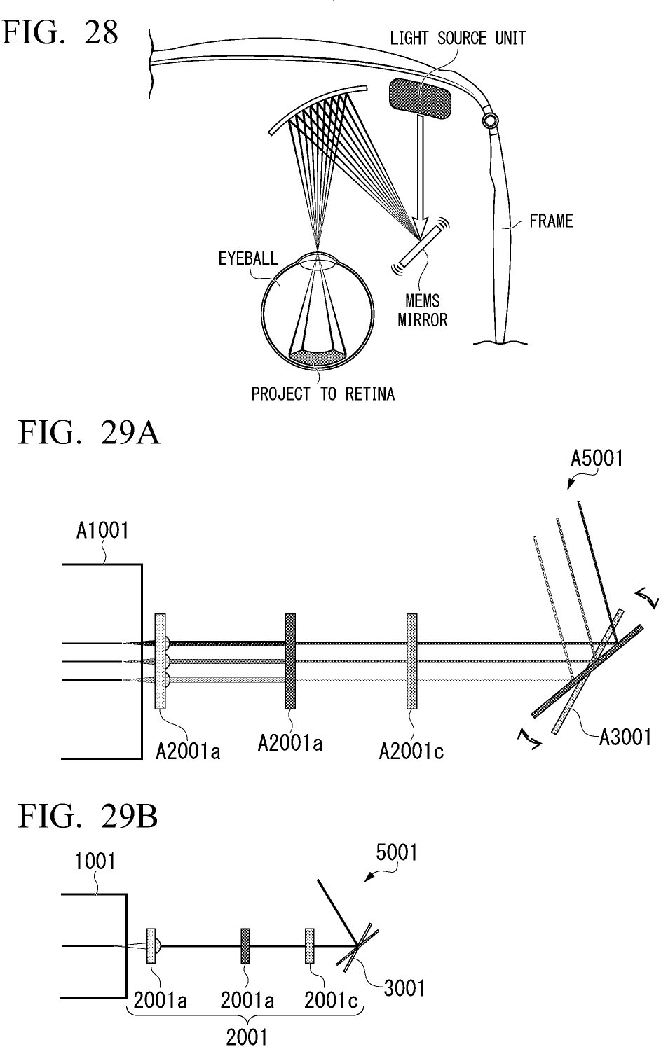

As shown in FIG. 28, the laser beam emitted from the light source unit 1001 attached to the spectacle frame is reflected by the optical scanning mirror and enters the human eye, where the image (video) is projected directly onto the retina.

In addition, as the light source unit 1001, a unit including a multiplexing part having a near infrared light module, in addition to the three optical modules of RGB of the red optical module, the green optical module and the blue optical module, and configured to multiplex the RGB lights emitted from the RGB optical modules and the light emitted from the near infrared light module to a single beam can be used.

In the configuration, the image is projected directly to the retina while performing the eye-tracking.

The optical scanning mirror 3001 is, for example, a MEMS mirror. In order to project a 2-D image, a 2-axis MEMS mirror configured to vibrate to change the angle in the horizontal direction (X direction) and the vertical direction (Y direction) and reflect the laser beam.

The optical engine 5001 is an optical system configured to optically process the laser beam emitted from the light source unit 1001, and includes a collimator lens 2001a, a slit 2001b, and an ND filter 2001c. The optical system is an example, and may have another configuration.

The optical engine 5001 has a laser driver 1100, an optical scanning mirror driver 1200, and a video controller 1300 configured to control these drivers.

FIG. 29A is a view schematically showing an optical engine A5001 (see Patent Literature 2), which does not include a multiplexing part or a multiplexer in a modulation device A1001. FIG. 29B is a view schematically showing the optical engine 5001 according to the embodiment having the multiplexing part in the light source unit 1001.

In the optical engine 5001 shown in FIG. 29B, since the three wavelengths are multiplexed and emitted from the light source unit 1001, each of the optical parts is one and can be miniaturized, and thus, it is easy to increase the resolution because white is made with one beam spot.

On the other hand, in the optical engine A5001 shown in FIG. 29A, since the multiplexing part or the multiplexer is not provided in the modulation device A1001, three color beam spot are required to emit white, and the beam spots become large, making it difficult to increase the resolution. In addition, since the three color beam spots are required, design of a collimate lens A2001a, a slit (or an aperture) A2001b, an ND filter A2001c, and a 2-axis MEMS mirror A3001 is increased, and the number of pieces is required, making it unsuitable for miniaturization.

### (Optical Communication Transmission Device)

The optical communication transmission device according to the embodiment includes the light source unit according to the above-mentioned embodiment.

In this case, miniaturization and reduction in cost are possible.

As the light emitted from the light source unit, visible light or near infrared light can be used.

When the visible light is used as the light emitted from the light source unit, a generating speed of a visible light signal can be increased.

With an increase in the processing speed of computers and an accompanying improvement in the processing capacity of information data, it is desired that the communication speed be further increased in the optical communication system. However, in a transmission device that generates a visible light signal by direct modulation, there is a limit to shortening the on/off switching time of the visible light source, and it is difficult to increase the generating speed of the visible light signal.

Moreover, as described in Patent Literature 3, when the visible light sources are arranged in an array, it may be difficult to be used for, for example, a small information terminal such as a smartphone because the size of a device becomes large. In addition, if the visible light sources are arranged in an array, data processing may be complicated. Furthermore, as easily expected without any explanation, the use of multiple laser light to increase data speed becomes very expensive. Such configuration is not realistic for consumer use application.

When the visible light is used as the light emitted from the light source unit using the optical communication transmission device according to the embodiment, a generating speed of the visible light signal can be increased, and miniaturization and reduction in cost can be realized.

FIG. 30 is a conceptual view for describing an optical communication transmission device according to the embodiment and a visible light signal generated by the transmission device. The transmission device according to the embodiment is a transmission device configured to transmit a visible light signal to a receiving device.

An optical communication transmission device 6001 according to the embodiment includes the light source unit 1000A having an optical semiconductor device (laser) 6030 and an optical modulator 6200, and an electrical signal generating device 6013. Hereinafter, an optical semiconductor device (laser) may be referred to as LD, and an optical modulator may be referred to as LN.

The laser 6030 emits visible light 1. The laser 6030 is continuously turned ON. Further, “continuous” means that the laser 6030 is in an ON state during a period in which a visible light signal is transmitted to the receiving device. A wavelength of the visible light 1 emitted by the laser 6030 is generally within a range of 380 nm or more and 830 nm or less.

The electrical signal generating device 6013 receives the transmitted information data, and outputs the data to the light source unit 1000A as an electrical signal.

The light source unit 1000A generates a visible light signal 2 through current modulation of the LD and voltage modulation of the LN on the basis of the electrical signal received from the electrical signal generating device 6013. When the visible light signal 2 is generated, only one of the current modulation of the LD and the voltage modulation of the LN may be used.

The optical modulator included in the optical modulator 6200 is a Mach-Zehnder type optical modulator. When generating the visible light signal 2 only by voltage modulation of LN, the time required to modulate the visible light 1 to the bright light 1a or the dark light 1b using a Mach-Zehnder optical modulator is shorter than the time required to switch on/off the visible light source. Accordingly, a transmission device 6001 increases a generating speed of the visible light signal 2.

### (Optical Communication System)

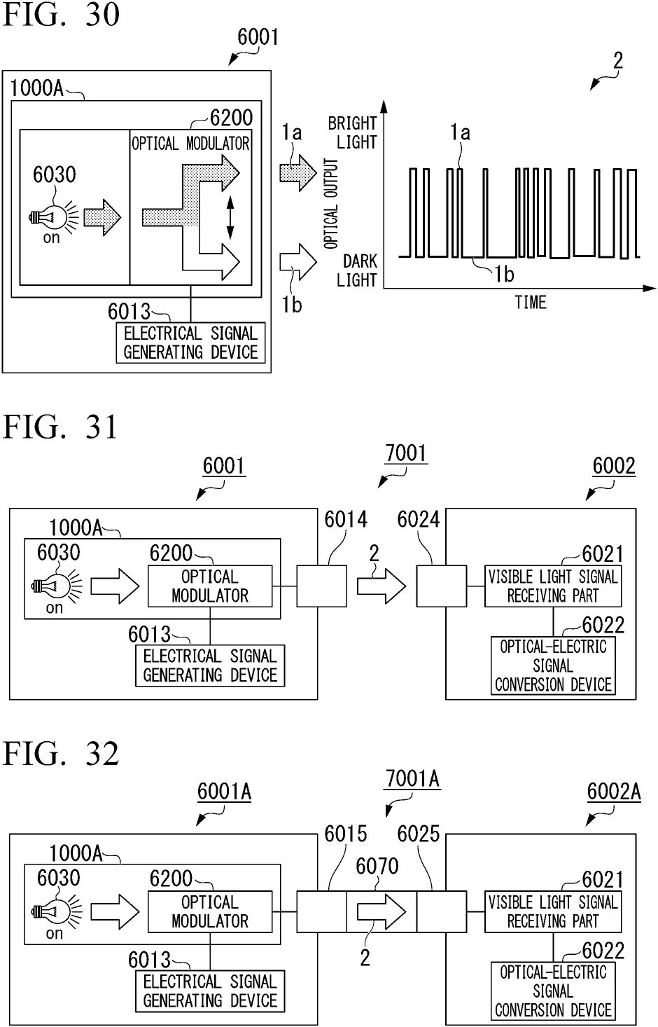

FIG. 31 is a block diagram of an optical communication system according to the embodiment.

An optical communication system 7001 shown in FIG. 31 transmits the visible light signal 2 generated by the optical communication transmission device 6001 to an optical communication receiving device 6002 via an external space.

The transmission device 6001 includes the laser 6030, the optical modulator 6200, the electrical signal generating device 6013, and a visible light signal exit port 6014. The transmission device 6001 is the same as the transmission device 6001 shown in FIG. 30, except that it includes the visible light signal exit port 6014. The visible light signal exit port 6014 is an exit port for connecting to the optical modulator 6200 and configured to emit the visible light signal 2 generated by the optical modulator 6200 to an external space.

The receiving device 6002 includes a visible light signal receiving part 6021, an optical-electric conversion device 6022, and a visible light signal incident port 6024. The visible light signal incident port 6024 is an incident port configured to receive the visible light signal 2 transmitted from the transmission device 6001. The visible light signal receiving part 6021 is connected to the visible light signal incident port 6024, and receives the visible light signal 2 entering the visible light signal incident port 6024 and radiates it to the optical-electric conversion device 6022. The optical-electric conversion device 6022 converts the visible light signal 2 into an electrical signal. The optical-electric conversion device 6022 is not particularly limited as long as the device can detect the visible light signal 2 at a high speed and convert it to an electrical signal, and any type of device may be used.

The optical communication system 7001 performs visible light communication as follows.

In the transmission device 6001, as described above, the visible light signal 2 is generated by the optical modulator 6200. The generated visible light signal 2 is emitted to an external space via the visible light signal exit port 6014.

The emitted visible light signal 2 is received by the visible light signal receiving part 6021 via the visible light signal incident port 6024 of the receiving device 6002. The received visible light signal 2 is converted into the electrical signal by the optical-electric conversion device 6022, and the information data attached to the visible light signal 2 is extracted.

According to the optical communication system 7001 according to the embodiment configured as described above, since the intensity of the visible light signal 2 transmitted from the transmission device 6001 is high, a communication path of the visible light signal 2 is easy to be visually confirmed. Accordingly, mistransmission of the data can be prevented. In the case of the communication system using infrared light, it is not possible to visually confirm whether the visible light signal is received by the receiving device of the transmission destination. For this reason, there is a risk that a visible light signal will be sent to a person who is not intended to receive. According to the optical communication system 7001 of the embodiment in which the data transmission speed per second can be increased to a high speed of 10 Gbit/s or more to 1 Tbit/s from several hundreds Gbit/s, while the amount of data that can be transmitted per second is also enormous, and a risk of sending data to a wrong person is increased while the communication system is very convenient. For this reason, a visible light communication, which can visually confirm whether a visible light signal is transmitted to a transmission destination and transmit data, has a great merit from a viewpoint of preventing erroneous transmission of data. Infrared light that cannot be seen is not always assured when data is transmitted.

Another merit of using visible light is that the size of the optical waveguide can be reduced because visible light has a shorter wavelength than infrared light. That is, the size of the optical modulator can be reduced. Since the size of the optical waveguide for visible light can be reduced by about ⅓ to ¼ per side as compared with the optical waveguide for infrared light, the area can be reduced to ⅑ to 1/16. That is, since the number of elements obtained per substrate for element creation is increased by about 10 times, a manufacturing cost of the optical modulator can be reduced to ⅑ to 1/16. For example, it is possible to realize consumer uses like information terminals such as smartphones. As long as infrared light is used, a chip size cannot be reduced. In other words, a cost of a modulation element is increased, and it is very difficult and impractical to use it for consumer uses.

As described above, the following two points can be mentioned as merits of using visible light for high-speed optical communication.

Transmission is possible after a transmission destination is visually confirmed in the high-speed optical communication, and a large amount of data can be safely transmitted and received.

An element size of an optical modulator can be reduced. This makes it possible to reduce a manufacturing cost of the optical modulator to ⅒ or less. As a result, it is possible to enjoy merits of ultra-high-speed communication even in consumer uses.

In the optical communication system of the embodiment, a light transmission means such as an optical fiber or the like may be used for the visible light signal.

FIG. 32 is a block diagram showing a variant of an optical communication system according to another embodiment.

The optical communication system 7001A shown in FIG. 32 is different from a communication system 7001 shown in FIG. 31 in that the visible light signal 2 generated by the transmission device 6001A is transmitted to the receiving device 6002A via an optical fiber 6070.

In the optical communication system 7001A shown in FIG. 32, the transmission device 6001A includes the laser 6030, the optical modulator 6200, the electrical signal generating device 6013, and an optical fiber connecting part 6015 for output. The optical fiber connecting part 6015 for output is a connecting part configured to connect the optical modulator 6200 and the optical fiber 6070 and output the visible light signal 2 generated in the optical modulator 6200 to the optical fiber 6070.

The receiving device 6002A includes the visible light signal receiving part 6021, the optical-electric conversion device 6022, and an optical fiber connecting part 6025 for input. The optical fiber connecting part 6025 for input is a connecting part configured to connect the optical fiber 6070 and the visible light signal receiving part 6021 and input the visible light signal 2 transmitted through the optical fiber 6070 to the visible light signal receiving part 6021.

The optical communication system 7001A performs visible light communication as follows.

In the transmission device 6001A, as described above, the visible light signal 2 is generated in the optical modulator 6200. The generated visible light signal 2 is output to the optical fiber 6070 via the optical fiber connecting part 6015 for output. The output visible light signal 2 propagates through the optical fiber 6070 and is received by the visible light signal receiving part 6021 via the optical fiber connecting part 6025 for input of the receiving device 6002A. The received visible light signal 2 is converted into electrical signal by the optical-electric conversion device 6022, and information data provided to the visible light signal 2 is extracted.

According to the communication system 7001A of the embodiment having the above-mentioned configuration, since the visible light signal 2 generated in the transmission device 6001A is transmitted to the receiving device 6002A via the optical fiber 6070, for example, the visible light signal 2 can be transmitted to a place where light cannot pass such as a room partitioned by walls.

FIG. 33 is a view showing an example of a use example of an information terminal according to the embodiment.

In FIG. 33, smartphones 6091a and 6091b include the transmission device 6001 and the receiving device 6002 shown in FIG. 31, respectively. The smartphones 6091a and 6091b have flat surfaces having displays and side surfaces, the visible light signal exit port 6014 of the transmission device 6001a is exposed to one side surface, and the visible light signal incident port 6024 of the receiving device 6002 is provided on the flat surface having the display.

When the data are transmitted to the smartphone 6091b from the smartphone 6091a, the visible light signal 2 is transmitted in a state in which the visible light signal exit port 6014 of the smartphone 6091a is directed toward the visible light signal incident port 6024 of the smartphone 6091b. Meanwhile, when the data are transmitted to the smartphone 6091a from the smartphone 6091b, the visible light signal 2 is transmitted in a state in which the visible light signal exit port 6014 of the smartphone 6091b is directed toward the visible light signal incident port 6024 of the smartphone 6091a.

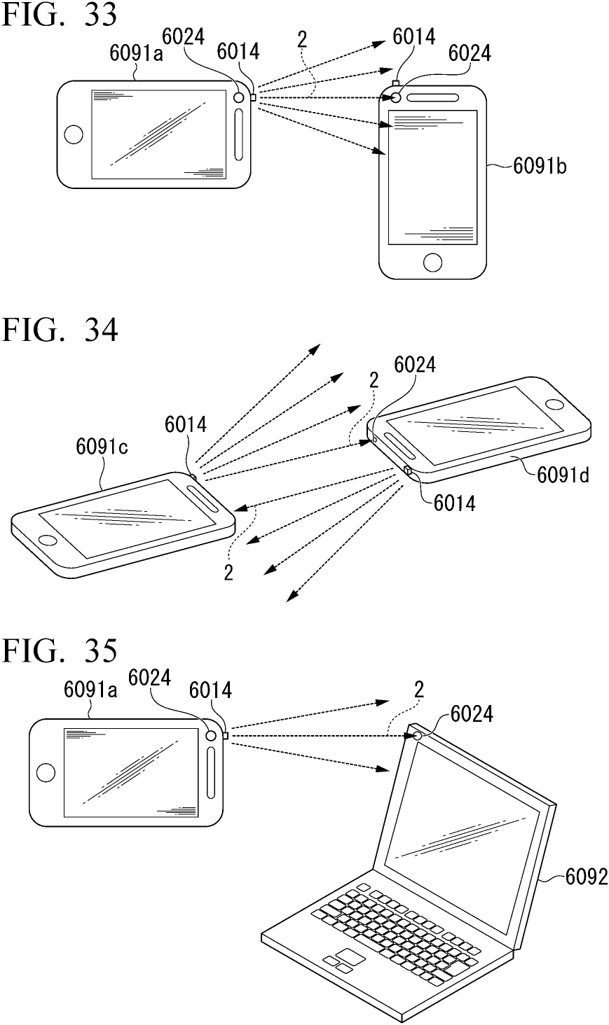

FIG. 34 is a view showing another example of a use example of the information terminal according to the embodiment.

In FIG. 34, smartphones 6091c and 6091d include the transmission device 6001 and the receiving device 6002 shown in FIG. 31, respectively. The smartphones 6091c and 6091d have flat surfaces having displays and side surfaces, and the visible light signal exit port 6014 of the transmission device 6001 and the visible light signal incident port 6024 of the receiving device 6002 are exposed to one side surface.

When the data are transmitted between the smartphone 6091c and the smartphone 6091d, the visible light signal 2 is transmitted in a state in which the visible light signal exit port 6014 and the visible light signal incident port 6024 of the smartphone 6091c, and the visible light signal exit port 6014 and the visible light signal incident port 6024 of the smartphone 6091d face each other.

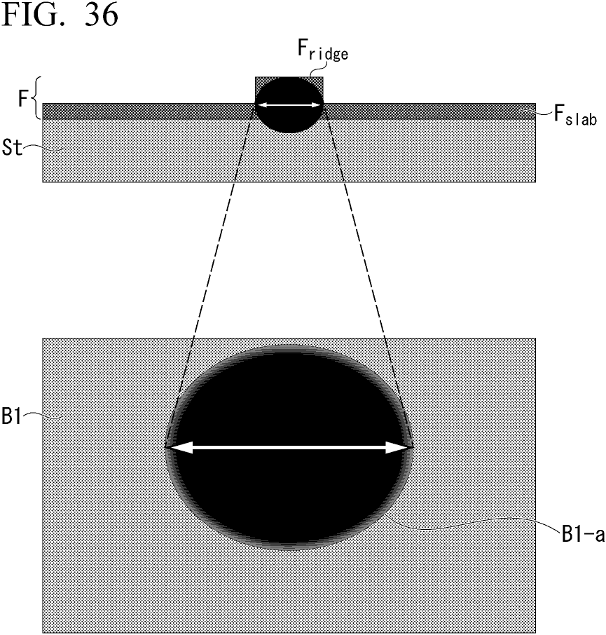

FIG. 35 is a view showing still another example of a use example of the information terminal according to the embodiment.

In FIG. 35, the smartphone 6091a includes the transmission device 6001 and the receiving device 6002 shown in FIG. 31. The smartphone 6091a has a flat surface having a display and side surfaces, the visible light signal exit port 6014 of the transmission device 6001 is exposed to one side surface, and the visible light signal incident port 6024 of the receiving device 6002 is provided on the flat surface having the display. Meanwhile, a personal computer 6092 includes the receiving device 6002 shown in FIG. 31. The visible light signal incident port 6024 is exposed to the vicinity of the display of the personal computer 6092.

When the data are transmitted to the personal computer 6092 from the smartphone 6091a, the visible light signal 2 is transmitted in a state in which the visible light signal exit port 6014 of the smartphone 6091a is directed toward the visible light signal incident port 6024 of the personal computer 6092.

FIG. 33 to FIG. 35 show an example of a use example of the information terminal according to the embodiment, and the information terminal of the embodiment is not limited thereto. The information terminal may be, for example, a tablet.

### EXPLANATION OF REFERENCES

10-1, 10-2, 10-3 Mach-Zehnder type optical waveguide
11, 12 Optical waveguide
30, 30-1, 30-2, 30-3, 6030 Optical semiconductor device
40-1, 40-2, 6013 Electrical signal generating device
50 Multiplexing part
100 Light source part
115 Groove portion
200, 201, 202, 203, 204, 205, 6200 Optical modulator
1000, 1000A, 1001, 1010 Light source unit
2001 Optical system
3001 Optical scanning mirror
5001 Optical engine
6001, 6001A, 6001a Optical communication transmission device
6002, 6002A Optical communication receiving device
7001, 7001A Optical communication system

What is claimed is:

1. A light source unit, comprising:
a light source part having an optical semiconductor device;
a first electrical signal generating device configured to generate an electrical signal to control current that drives the optical semiconductor device;
an optical modulator having a Mach-Zehnder type optical waveguide with a lithium niobate film processed in a convex shape, and an electrode configured to apply an electric field to the Mach-Zehnder type waveguide; and
a second electrical signal generating device configured to generate an electrical signal to control a voltage that operates the optical modulator,
wherein the optical semiconductor device and the optical modulator are optically connected to each other,
the first electrical signal generating device and the second electrical signal generating device are synchronizably connected to each other; and
the intensity of light emitted from the optical modulator is changed by current modulation controlled by the first electrical signal generating device and voltage modulation controlled by the second electrical signal generating device.

2. The light source unit according to claim 1, wherein the first electrical signal generating device and the second electrical signal generating device are formed on a common semiconductor substrate.

3. The light source unit according to claim 1, wherein a minimum value of a change of light intensity by the first electrical signal generating device is greater than a minimum value of a change of light intensity by the second electrical signal generating device.

4. The light source unit according to claim 1, wherein a minimum value of a change of light intensity by the second electrical signal generating device is greater than a minimum value of a change of light intensity by the first electrical signal generating device.

5. The light source unit according to claim 1, wherein a peak wavelength of the optical semiconductor device is visible light of 380 nm to 830 nm.

6. The light source unit according to claim 1, wherein a peak wavelength of the optical semiconductor device is near infrared light of 830 nm to 2000 nm.

7. The light source unit according to claim 1, further comprising a plurality of optical modules in which the optical semiconductor devices and the optical modulators are optically connected,
wherein the plurality of optical modules are independently controlled.

8. The light source unit according to claim 7, wherein light emitted from the optical modulators of the different optical modules of the plurality of optical modules is emitted from separate light exit ports.

9. The light source unit according to claim 7, further comprising a multiplexing part configured to multiplex the light from the different optical modules of the plurality of optical modules,
wherein the multiplexed light passing through the multiplexing part is emitted from one light exit port.

10. The light source unit according to claim 9, wherein the optical semiconductor devices of the different optical modules emit visible light with a peak wavelength of 380 nm to 830 nm, and light emitted from the light exit port is visible light.

11. The light source unit according to claim 7, wherein the plurality of optical modules have at least:
a blue optical module having the optical semiconductor device with a peak wavelength of 380 nm to 500 nm;
a green optical module having the optical semiconductor device with a peak wavelength or 500 nm to 600 nm; and
a red optical module having the optical semiconductor device with a peak wavelength of 600 nm to 830 nm, and
a visible light multiplexing part configured to multiplex the light from the red optical module, the light from the green optical module and the light from the blue optical module is provided, and the multiplexed visible light passing through the visible light multiplexing part is emitted from one visible light exit port.

12. The light source unit according to claim 11, further comprising a near infrared light module having an optical semiconductor device that emits near infrared light with a peak wavelength of 830 nm or more,
wherein a near infrared light exit port from which the near infrared light is emitted is provided separately from the visible light exit port.

13. The light source unit according to claim 11, further comprising a near infrared light module having an optical semiconductor device that emits near infrared light with a peak wavelength of 830 nm or more,
wherein a multiplexing part configured to multiplex the visible light emitted from the visible light multiplexing part and the near infrared light emitted from the near infrared light module is provided, and the multiplexed light passing through the multiplexing part is emitted from one light exit port.

14. An optical engine comprising:
the light source unit according to claim 1;
an optical scanning mirror configured to scan light emitted from the light source unit in different directions; and
a control device configured to control the optical scanning mirror.

15. A smart glass comprising the optical engine according to claim 14, and a spectacle frame.

16. An optical communication transmission device comprising the light source unit according to claim 1.

17. An optical communication system comprising:
the optical communication transmission device according to claim 16; and
an optical communication receiving device having an optical signal receiving device configured to receive light.
